(19) United States
(12) Patent Application Publication
(10) Pub. No.: US 2017/0121200 A1
(43) Pub. Date: May 4, 2017

(54) Systems for Treating Water

(71) Applicant: zNano LLC, San Jose, CA (US)

(72) Inventor: Adrian Brozell, Los Gatos, CA (US)

(21) Appl. No.: 15/315,102

(22) PCT Filed: Jun. 1, 2015
(86) PCT No.: PCT/US15/33629

§ 371 Date: Nov. 30, 2016

Related U.S. Application Data
(60) Provisional application No. 62/005,846, filed on May 30, 2014.

(51) Int. Cl. C02F 9/00; B01D 61/14; B01D 61/04; B01D 61/02

(52) U.S. Cl. CPC C02F 9/00; B01D 61/025; B01D 61/147; B01D 61/145; B01D 61/04; B01D 2311/2649; C02F 1/441

(57) ABSTRACT

A system for treating wastewater, such as laundry water or car wash water, using a combination of microfiltration and/or ultrafiltration membranes and reverse osmosis. The system can use these elements to pretreat water that is then filtered by a media filter to reduce turbidity.

### CROSS-REFERENCE TO RELATED APPLICATIONS

This application claims priority to and the benefit of the filing of U.S. Provisional Patent Application Ser. No. 62/005,846, filed May 30, 2014, entitled “Systems for Treating Wastewater”, and the specification, figures, and claims thereof are incorporated herein by reference.

### BACKGROUND OF THE INVENTION

Field of the Invention (Technical Field)

The present invention is directed toward processes and systems to filter and recycle wastewater from sewer water, sanitary sewer water, reclaimed water, and/or greywater. In some embodiments, a microfiltration or an ultrafiltration membrane is followed by a reverse osmosis membrane, producing water that is comparable to tap water.

Description of Related Art

Note that the following discussion may refer to a number of publications by author(s) and year of publication, and that due to recent publication dates certain publications are not to be considered as prior art vis-à-vis the present invention. Discussion of such publications herein is given for more complete background and is not to be construed as an admission that such publications are prior art for patentability determination purposes.

Wastewater is difficult to treat because of the variation in the concentrations of one or more solutes. Solutes to be removed include but are not limited to solids, particles, colloids, virus, bacteria, hardness, salinity, organics, surfactants, and waxes. The concentration of solutes can vary because of variations chemicals being used in a process, the step being performed in a process, the time of year, the time of day, the frequency of or time since the last cleaning of some or all of the components in the water reuse system, rare material or events resulting in unexpected solutes in the wastewater, for example. In addition, solutes may not be static in shape, size, or chemical composition. For example, solutes may be coagulating, reactive, oxidizing, pH adjustors, or neutralizers. In addition, while reverse osmosis typically removes >90% of salinity from water, it only treats between about 40%-80% of incoming water depending on the system's design. In addition, reuse of wastewater is regulated to ensure the safety of the public. For example, the California Department of Health has an annually updated which defines how wastewater should be treated as per reuse application. These treatment requirements are for the safety of the public and may or may not be sufficient for an application depending on the source of the wastewater and the use of the recycled water. Typically, safety regulations are focused upon disinfection, virus removal, preventing cross contamination with the potable water line, and automatically bypassing the system in case of system malfunction. End users may have requirements including pH, molecule removal, salinity, hardness, color, clarity, and odor for example.

### SUMMARY OF THE INVENTION

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating an embodiment or embodiments of the invention and are not to be construed as limiting the invention. In the drawings:

FIG. 1 is a process flow diagram of the three step process to filter wastewater to produce low TDS non potable water and non potable water.

FIG. 2 is the first piping and instrumentation diagram symbol key for the drawings in this document.

FIG. 3 is the second piping and instrumentation diagram symbol key for the drawings in this document.

FIG. 4 is a process flow diagram of an embodiment of the reclaim system of the present invention in which the application or appliance produces wastewater which is captured in a settling and equalization capture tank. A pump removes the water from the tank. The pump or automatic valve is protected from solids by a porous barrier. Water is processed through a mechanical flocculation/coagulation/filtration/strainer process step and stored in an equalization tank. A meter measures the physical properties of the water and allows water to pass if the properties are within an acceptable range. Physical properties include but are not limited to pH, oxidation potential, and temperature. Examples of acceptable ranges are temperatures less than 113 F, oxidation reduction potentials below 550 mV+/−100 mV depending on the oxidant, and pH between 2-11.

FIG. 5 are process flow diagrams illustrating three different configurations for water reclaim tanks for the first step of the process.

FIG. 6 shows an exemplary piping and instrumentation diagram illustrating three different configurations for water reclaim tanks for the first step of the process.

FIG. 7 is an exemplary piping and instrumentation diagram illustrating one configuration of the complete first step of the process using the third option for tank configuration from FIG. 6. Waste laundry water is oxidized when it falls into a tank. A sump pump, which is protected by a porous barrier, pumps water through a mechanical flocculation/coagulation/filtration/strainer process step before being stored in an equalization tank.

FIG. 8 is a process flow diagram of the second step of the process where the wastewater is filtered then the water is sorted for primary and secondary applications based on water quality needs. The secondary application is optional. If there is no secondary application, the media filtration and disinfection steps are removed, and the water is used for washing and backwashing the first organic removal step even if the organic removal step is a component of the reclaim system.

FIG. 9 is an exemplary piping and instrumentation diagram of the second step of the process, the filtration system. The diagram shows a complete filtration system with water reuse tanks for both a primary and secondary application. There are seven steps of treatment. They are: settling (not shown), filtration (not shown), coagulation/emulsification (via injection from the chemical cleaning reservoir), ultrafiltration, reverse osmosis, media filtration and uv disinfection. The reject from the reverse osmosis can be passed through a media filter and a disinfection step (such as uv disinfection, ozone, or chlorination) for a secondary application. Secondary applications include wetting of cars, clothes, and materials as the first step in a wash process. Reuse of water from the secondary water reuse tank is optional. If there is no secondary application, the media filtration and disinfection steps are removed, and the water is used for washing and backwashing the first organic removal step even if the organic removal step is a component of the reclaim system.

FIG. 10 is a graph demonstrating the sub 300 microsiemens permeate water quality of the primary line of the filtration system and the energy savings, as heated water, of the system over six days.

FIG. 11 is a graph comparing pH response of filtered wastewater to tap water. The filtered wastewater achieves the target pH with 90% less detergent. Almost half of detergent is pH adjustor. The figure shows a titration of recycled wastewater and tap water via the addition of laundry soap. As laundry soap is added, the pH of both solutions increases. The recycled wastewater achieves the target pH of 10.0 with 75% less detergent than tap water.

FIG. 12 is a process flow diagram of the third step of a reverse pore size filtration process where the filtered/recycled water is returned to the primary or secondary application if it is of sufficient quality. The barrier to filtration that has the smallest pore size comes first. Therefore even pressure from one pump can be used to filter water at several different pore sizes. Additional application specific treatments can include such treatments as detergent mixing, chemical mixing, and/or ozone addition. These features can treat the recycled water for pH, osmotic strength, odor, and other parameters.

FIG. 13 is an exemplary piping and instrumentation diagram of the third step of the water reuse process. Water is sorted to two classes of applications: primary and secondary. Water may be treated for a specific application as part of the third step of the process. Make up water is provided via a control valve connected to the potable water line. Potable water is protected via a reduced pressure back flow prevention device. Membrane wash water can be simultaneously applied to multiple membranes without fear of cross contamination.

FIG. 14 is a graph of the gallons of water reused over a 15 day period from an embodiment of this invention. The system shuts off if the permeate water is above 300 ppm.

FIGS. 15-16 show filtration data taken from a system of the present invention.

FIG. 17 is a water flow diagram of a typical carwash. Tap water is used for both the Prep and the Rinse steps of the carwash.

FIG. 18 is a diagram of a Spot Free Reuse Water Process of the present invention. Instead of wasting additional tap water for both the Prep and Rinse steps of the carwash, reclaim water is purified and used.

FIG. 19 is a diagram of a system in which the retentate from the reverse osmosis (RO) membrane is sorted to increase the water recovery percentage. The retentate from the reverse osmosis (RO) membrane is sorted to increase the water recovery percentage. The sorting involves three steps. The first step is open a valve (A) to recycle the retentate of RO process by plumbing the water back to the inlet of the pump. If the pressure on the inlet exceeds a range of acceptable values, a second (B) valve can be opened to recycle the retentate back to the Equalization Tank #N where N is the highest value of N in the system. Typical influent water is between 200-2,000 ppm of total dissolved solids (TDS). In some embodiments of the invention, brackish water RO membranes are employ which are rated to handle 2,000 ppm of TDS. In some embodiments of the invention, seawater RO membranes are employ which are rated to handle 35,000 ppm of TDS. If the TDS of the retentate exceeds an acceptable range, then a valve is opened to drain the retentate. The recycle drain may be closed when the TDS exceeds acceptable levels. One condition where the valve would be closed is when the TDS has exceeded acceptable levels for a long time, i.e. one or more minutes; one or more hours.

FIG. 20 is a process flow diagram showing the locations of load leveling tanks in the filtration process. The load leveling tanks are designed to hold water for 1-240 minutes of operation, and are necessary because of the cyclic nature of both the water disposal from the application and the water demand from the application.

FIG. 21 is a process flow diagram showing the locations of load leveling tanks are in the filtration process when there are multiple output streams for applications from the filtration system. The load leveling tanks are designed to hold water for 1-240 minutes of operation, and are necessary because of the cyclic nature of both the water disposal from the applications and the water demand from the applications.

FIG. 22 is a piping and instrumentation diagram of a method to prevent overflow of the equalization tank without controlling the sump pump. Wastewater is produced from the application, oxidized and stored in a capture tank. When the equalization tank is full, the valve closes to prevent overflow. A mechanical flocculation/coagulation/filtration/strainer process step can be part of the process. This configuration enables electrical isolation of the sump pump from the filtration system.

FIG. 23 is a process flow diagram of the reclaim system in one embodiment of this invention. In this embodiment, the application or appliance produces wastewater which is captured in a settling and equalization capture tank. A pump removes the water from the tank. The pump or automatic valve is protected from solids by a porous barrier. Water is processed through a mechanical flocculation/coagulation/filtration/strainer process step and stored in an equalization tank. A meter measures the physical properties of the water and adjusts them to meet the filtration system's operating requirements. Physical properties include but are not limited to pH, oxidation potential, and temperature. Examples of acceptable ranges are temperatures less than 113 farenheit, oxidation reduction potentials below 550 mV+/−100 mV depending on the oxidant, and pH between 2-11.

FIG. 24 is a piping and instrumentation diagram of a method to condition water in the equalization tank for use in the filtration system. Wastewater is produced from the application, oxidized and stored in a capture tank. When the equalization tank is full, the valve closes to prevent overflow. A mechanical flocculation/coagulation/filtration/strainer process step can be part of the process. The meter in the equalization tank monitors the physical property being changed. The physical property could be but is not limited to pH, oxidation reduction potential, and temperature. This is particularly relevant in laundry applications where oxidizing detergents such as bleach are commonly used.

FIG. 25 is a piping and instrumentation diagram of a method to present oxidizing moieties inline to an equalization tank for use in the filtration system. Wastewater is produced from the application, oxidized and stored in a capture tank. A mechanical flocculation/coagulation/filtration/strainer process step can be part of the process. Water is oxidized using chemical and/or electrical sources of singlet molecular oxygen or ozone. A meter controls both the dosing of anti oxidant and the filtration system where antioxidant is dosed and the filtration system is off when the ORP is greater than 550 mV+/−10 mV and the antioxidant is not dosed and the filtration systems is on when the ORP is less than 550 mV+/−100 mV. The range of ORP represents the variations in the activity of the oxidants used and oxidant tolerances of the filtration unit. In cleaning modes, the filtration system may be turned on and the anti oxidant dosing turned off when the ORP is greater than 550 mV. This is particularly relevant in carwash applications where organics, such as wax, foul membranes. Other meters in the equalization tank monitors the physical property being changed. The physical property could be but is not limited to pH, oxidation reduction potential, and temperature. In this application, the meter can monitor oxidation reduction potential to neutralize remaining inline oxidants after the inline oxidation step.

FIG. 26 is a piping and instrumentation diagram of a method to present oxidizing moieties inline to an equalization tank for use in the filtration system. Wastewater is produced from the application, oxidized and stored in a capture tank. A mechanical flocculation/coagulation/filtration/strainer process step can be part of the process. Water is oxidized using chemical and/or electrical sources of singlet molecular oxygen, ozone or chlorine. The meter in the equalization tank monitors the physical property being changed. The physical property could be but is not limited to pH, oxidation reduction potential, and temperature. In this application, the meter can monitor oxidation reduction potential to neutralize remaining inline oxidants after the inline oxidation step. This is particularly relevant in blackwater applications to prevent active biologic contaminant from entering into the filtration process.

FIG. 27 is a piping and instrumentation diagram of a method to present oxidizing moieties into a sterilization tank for use in the filtration system. Wastewater is produced from the application, oxidized and stored in a capture tank. A mechanical flocculation/coagulation/filtration/strainer process step can be part of the process but is typically omitted to prevent accumulation of biohazards on the filter surfaces. Water is oxidized using chemical and/or electrical sources of singlet molecular oxygen, ozone or chlorine dosed into the sterilization tank. A meter in the sterilization tank monitors the quality of the sterilization process. A second valve and or pumping system allows the sterilized water to flow into a neutralization tank. Backflow is prevented using either double backflow preventors or an air gap. In the neutralization tank, anti oxidant is added to bring the oxidation reduction potential to below 550 mV enabling the filtration system to operate. A meter controls both the dosing of anti oxidant and the filtration system where antioxidant is dosed and the filtration system is off when the ORP is greater than 550 mV+/−10 mV and the antioxidant is not dosed and the filtration systems is on when the ORP is less than 550 mV+/−100 mV. The range of ORP represents the variations in the activity of the oxidants used and oxidant tolerances of the filtration unit. In cleaning modes, the filtration system may be turned on and the anti oxidant dosing turned off when the ORP is greater than 550 mV.

FIG. 28 is a diagram of a common solids trap used on the reclaim tank. A union is placed above the drain valve to enable removal of the trap without spilling water. The drain valve is orthogonal to gravity to prevent accumulation of solids on the drain valve. The drain valve is typically an large port valve such as a ball or butterfly valve. After the tank is drained, the union above the valve is disconnected. Typically, a soft connection is used between the valve and the drain allowing for the remaining water in the trap and the valve to be poured into a container. The additional union on the trap allows for the removal of the trap only after the remaining water in the trap has been removed. The trap has a larger removable cap or plug to enable the removal of trapped solids. The trap diameter is the same size or larger than the diameter than the diameter of the port on the bottom of the tank.

FIG. 29 is a piping and instrumentation diagram of a method to prevent overflow of the capture tank when capturing water from washing machines with drain pumps. Wastewater is produced from the washing machines and pump to the washing machine's drain. The drain is plumbed into a tank which stores the water. When the tank is full, the control valve connecting the washing machine and the drain closes, and the control valve plumb to the drain opens which allows the excess water to be drained away. Water can be transferred between the capture tank and the equalization tank via pump or control valve. A strainer with openings between 0.01″ and 1″ can be used to protect the automatic valve and/or pump. A back flow prevention device, such as a double swing check valve or an air gap, prevents the flow of water from the equalization tank to the capture tank.

FIG. 30 is a process flow diagram showing an embodiment of the invention where there is a waste removal step followed by a molecular separation step, and concluding with a reverse osmosis or forward osmosis step. The forward osmosis/reverse osmosis step is activated by a pressure sensor on the filtered side of the separation of molecules step. After reverse or forward osmosis, there is an optional oxidation step. The molecular separation step can be a microfiltration membrane, an ultrafiltration membrane, or a combination of the two.

FIG. 31 is a process flow diagram showing an embodiment of the invention where there are two waste removal steps followed by a reverse osmosis or forward osmosis step. The forward osmosis/reverse osmosis step is activated by a pressure sensor on the filtered side of the separation of molecules step. After reverse or forward osmosis, there is an optional oxidation step. The waste removal steps can be a microfiltration membrane, an ultrafiltration membrane, or a combination of the two.

FIG. 32 is an exemplary P&ID of a laundry water recycling system without a recycling of the RO retentate where the water is treated in a 6 step process that involves settling, filtration, ultrafiltration, reverse osmosis, media filtration, and ultraviolet disinfection. The filtration unit is a passive unit that must be cleaned manually such as a filter press, or cartridge filter. The filtration unit has a pore size less than 300 microns. This method enables higher water recovery. In some embodiments, there is a strainer installed in front of the ultrafiltration membrane. In some embodiments, detergent is added to the first equalization tank to emulsify dissolved organics. In some embodiments, there is a porous barrier in front of the sump pump to protect it from large debris. The barrier typically has openings smaller than 0.25″ in diameter. Pressure on the reverse osmosis membrane is controlled using a flow restrictor such as a pressure relief valve, small diameter pipe (<⅜″) or flow restrictor. The reverse osmosis retentate is either recycled (A), or drained (C).

FIG. 33 is an exemplary P&ID of a laundry water recycling System with a recycle of the RO retentate where the water is treated in a 6 step process that involves settling, filtration, ultrafiltration, reverse osmosis, media filtration, and ultraviolet disinfection. The filtration unit is an passive unit that must be cleaned manually such as a filter press, or cartridge filter. The filtration unit has a pore size less than 300 microns. This method enables higher water recovery. In some embodiments, there is a strainer installed in front of the ultrafiltration membrane. In some embodiments, detergent is added to the first equalization tank to emulsify dissolved organics. In some embodiments, there is a porous barrier in front of the sump pump to protect it from large debris. The barrier typically has openings smaller than 0.25″ in diameter. Pressure on the reverse osmosis membrane is controlled using a flow restrictor such as a pressure relief valve, small diameter pipe (<⅜″) or flow restrictor. The reverse osmosis retentate is either recycled (A), returned to the equalization tank (B), or drained (C).

FIG. 34 is an exemplary Laundry Water Recycling System where the water is treated in a 6 step process that involves settling, filtration, ultrafiltration, reverse osmosis, media filtration, and ultraviolet disinfection. The filtration unit is an active unit that allows for automatic disposal and collection of solid waste such as a centrifugal separator, belt filter, spin disc, disc filter, or drum filter. The filtration unit has a pore size less than 300 microns. The waste from the filtration unit can treated in a settling tank before being processed again by the filtration unit. This method enables higher water recovery. In some embodiments, there is a strainer installed in front of the ultrafiltration membrane. In some embodiments, detergent is added to the first equalization tank to emulsify dissolved organics. In some embodiments, there is a porous barrier in front of the sump pump to protect it from large debris. The barrier typically has openings smaller than 0.25″ in diameter. Pressure on the reverse osmosis membrane is controlled using a flow restrictor such as a pressure relief valve, small diameter pipe (<⅜″) or flow restrictor. The reverse osmosis retentate is either recycled (A), returned to the equalization tank (B), or drained (C).

FIG. 35 is an exemplary Laundry Water Recycling System where the water is treated in a 6 step process that involves settling, filtration, ultrafiltration, reverse osmosis, media filtration, and ultraviolet disinfection. The filtration unit is an active unit that allows for automatic disposal and collection of solid waste such as a centrifugal separator, belt filter, spin disc, disc filter, or drum filter. The filtration unit has a pore size less than 300 microns. The waste from the filtration unit can treated in a settling tank before being processed again by the filtration unit. This method enables higher water recovery. In some embodiments, there is a strainer installed in front of the ultrafiltration membrane. In some embodiments, detergent is added to the first equalization tank to emulsify dissolved organics. In some embodiments, there is a porous barrier in front of the sump pump to protect it from large debris. The barrier typically has openings smaller than 0.25″ in diameter. Pressure on the reverse osmosis membrane is controlled using a flow restrictor such as a pressure relief valve, small diameter pipe (<⅜″) or flow restrictor. The reverse osmosis retentate is either recycled (A), returned to the equalization tank (B), or drained (C).

FIG. 36 is an exemplary piping and instrumentation diagram of the second step of the process, the filtration system. The diagram shows a complete filtration system with water reuse tanks for both a primary and secondary application. There are seven steps of treatment. They are: settling (not shown), filtration (not shown), coagulation/emulsification (via injection from the chemical cleaning reservoir), ultrafiltration, reverse osmosis, media filtration and uv disinfection. The reject from the reverse osmosis can be passed through a media filter and a disinfection step (such as uv disinfection, ozone, or chlorination) for a secondary application. Secondary applications include wetting of cars, clothes, and materials as the first step in a wash process. Reuse of water from the secondary water reuse tank is optional. If there is no secondary application, the media filtration and disinfection steps are removed, and the water is used for washing and backwashing the first organic removal step even if the organic removal step is a component of the reclaim system.

FIG. 37 shows the water quality performance of an embodiment of the invention. On average, 96.2% of total dissolved solids (TDS) are removed with a resulting permeate of 65.1 micro Siemens at an average temperature of 93.8 farenheit with an average retentate TDS concentration of 1722. Temperatures range from 70-110 Fahrenheit.

FIG. 38 shows the process flow diagram for media filtration based water reuse. The pretreatment to the media filter is a combination of ultrafiltration and reverse osmosis. The ultrafiltration can be microfiltration or microfiltration followed by ultrafiltration. The UV disinfection step can be ozone, chlorine dosing, or any other alternative disinfection method that has been proven in inactivate 99.99% of fecal coliform or produces 2 ppm of free chlorine. The permeate from the reverse osmosis is continuously monitored to ensure that the turbidity is less than 2 NTU. Turbidity may be measured indirectly by measuring total dissolved solids (TDS).

FIG. 39 is a graph demonstrating the daily performance of the laundry water unit over the course of 6 months. The filtration performance is plotted in terms of average gallons recycled per day, and normalized to the performance on the final day of monitoring.

FIG. 40 is a graph demonstrating the water quality as measured by TDS over a 3 month period, with a line showing the average tap water quality for reference. The table below the graph gives the numerical values of the min, max, and average TDS for Walnut Creek, the zNano water filtration unit, and percentage improvement of the zNano unit compared to the Walnut Creek tap water

FIG. 41 demonstrates the difference in optical clarity between zNano pretreated and untreated wastewaters. The graph containing the values for the optical clarity are overlaid over the image used to compare the optical clarity. The value of the conductivities of each of the wastewater streams in microSiemens (mS) is also included.

FIG. 42 compares an RO filtration system's performance when filtering microfiltration (0.1 micron) pretreated wastewater vs. untreated wastewater. The wastewater was from a carwash. The top left shows a comparison of filtration rate between the pretreated (solid line) and the untreated (dashed line). The top right shows a comparison of filtration rate between the pretreated (solid line) and the untreated (dashed line) normalized to pressure. The bottom right plot is the total dissolved solids of the permeate of the pretreated (solid line) and the untreated (dashed line).

FIG. 43 compares the characteristics of a system using both UF and RO with a unit using only RO, summarizing the results from FIG. 42; the tables contain the averages of the plots in FIG. 42.

FIG. 44 compares the RO filtration performance in terms of GFD of anaerobic digester wastewater filtration. The filtration was performed at 100 psi, with a crossflow velocity of 100 cm/s. Four membrane samples were tested in parallel. The membrane samples used in the test were 3 in̂2 commercial RO membrane samples. Purified water was filtered for one hour as a baseline test, followed by filtration of wastewater. Samples were taken every 20 minutes. The pre-filtered anaerobic digester wastewater used in the RO filtration was prepared in two different ways. One method involved filtration though a 0.2 um PES membrane. The other method involved filtration though a 0.2 um PES membrane, followed by filtration though a 100k MWCO PES membrane.

FIG. 45 compares the RO filtration performance in terms of fouling rate of anaerobic digester wastewater filtration. The filtration was performed at 100 psi, with a crossflow velocity of 100 cm/s. Four membrane samples were tested in parallel. The membrane samples used in the test were 3 in̂2 commercial RO membrane samples. Purified water was filtered for one hour as a baseline test, followed by filtration of wastewater. Samples were taken every 20 minutes. The pre-filtered anaerobic digester wastewater used in the RO filtration was prepared in two different ways. One method involved filtration though a 0.2 um PES membrane. The other method involved filtration though a 0.2 um PES membrane, followed by filtration though a 100k MWCO PES membrane. The fouling rate is determined by normalizing the flux at each sampling time to the flux at 20 minutes.

FIG. 46 is a table that summarizes the RO filtration performance compared to the pure water flux of the RO membrane. The filtration was performed at 100 psi, with a crossflow velocity of 100 cm/s. Four membrane samples were tested in parallel. The membrane samples used in the test were 3 in̂2 commercial RO membrane samples. Purified water was filtered for one hour as a baseline test, followed by filtration of wastewater. Samples were taken every 20 minutes. The pre-filtered anaerobic digester wastewater used in the RO filtration was prepared in two different ways. One method involved filtration though a 0.2 um PES membrane. The other method involved filtration though a 0.2 um PES membrane, followed by filtration though a 100k MWCO PES membrane. The fouling rate is determined by normalizing the flux at each sampling time to the flux at 20 minutes.

FIG. 47 is a graph comparing the temperature of wastewater (“Retentate”), recycled water (‘Permeate’), and Tap Water. Tap water is an estimated value based on testing in Sacramento Calif. The wastewater maintains its temperature through the water recycling process such that the recycled water is >20 degrees F. warmer than the tap water.

### DETAILED DESCRIPTION OF THE INVENTION

### Definitions

As used throughout the specification and claims, the following terms are defined as follows:

“Amphiphile” means a molecule with both solvent preferring and solvent excluding domains.

“Surfactant” means a class of amphiphiles having at least one domain which is hydrophilic and at least one domain which is hydrophobic. Systems that are engineered to work with surfactants can most likely work with all amphiphiles.

“Mesophase” means a surfactant liquid crystal structure formed by the interactions between one or more solvents and one or more surfactants.

“Stabilized surfactant mesostructure” means a mesophase that maintains its structure after the removal of the solvents.

“Hollow fiber membrane” means a hollow porous cylindrical structure. This material is similar to a straw except it is porous. This material is typically used for aqueous separations.

“Membrane/semi permeable membrane” means a material used to separate specific classes of ions, molecules, proteins, enzymes, viruses, cells, colloids, and/or particles from other classes. A membrane/semi permeable membrane is permeable to solvent (e.g. water) and is impermeable to all or some solutes (e.g. NaCl).

“Osmotic pressure” means the pressure of a mixture as approximated by the ideal gas law.

“Osmosis” means a process in which water crosses a semi permeable membrane when it separates two volumes of water, where one volume has higher osmotic pressure.

“Reverse osmosis” or “RO” means a process that uses an osmotic pressure greater than zero to separate salt and water.

“Forward osmosis” or “FO” means a process that uses an osmotic gradient to create water flux.

“Emulsion” means a solution comprising water, at least one amphiphile, and oil.

“Filter” means a material used to remove solutes from solutions, including but not limited to a membrane, a microfiltration filter or membrane, an ultrafiltration filter or membrane, reverse osmosis filter or membrane, forward osmosis filter or membrane, hollow fiber membrane, and semi-permeable membrane.

“Total suspended solids” means solids removed by 0.2 micron (or smaller) filtration.

“Inverse flux curve” means the decrease in membrane flux as a result of increased applied pressure.

“Solid separator” means a water treatment device used to remove particles greater than 4.99 microns in size.

“Centrifugal filter” means a solid separator that uses centrifugal force.

“Spin disc filter” means a solid separator that uses plastic filters discs that spin to clean themselves. A spin disc filter is not the same as a disc filter.

“Drum filter” means a solid separator that uses a drum in combination with water jets.

“Filter press” means a solid separator that uses filters under mechanical pressure.

“Disc filter” is a solid separator that uses filter discs under mechanical pressure.

“Microfiltration” or “MF” means filtration using a membrane that has a mean pore size between 0.1 and 0.2 microns.

“Ultrafiltration” or “UF” means filtration using a membrane that has a molecular weight cutoff between 5k daltons and 250k daltons.

“Critical micelle concentration means the concentration above which a surfactant will form a mesostructured

“Emulsion” means a micelle comprised of surfactant bound to poorly soluble suspended solids and/or dissolved solids such as organics, molecules, proteins, solids, cells, and viruses.

“Catalytic oxidation” means the process of treating organic solutes in water by adding a catalytic oxygen source such as singlet molecular oxygen, hydrogen peroxide and/or ozone.

“UV-Ozone” means a catalytic oxidation process where ozone is created using UV light and oxygen in the water and/or from the air.

“Electric-Ozone” means a catalytic oxidation process where ozone is created using an electric field and oxygen in the water and/or from the air.

“Chlorination” means a sterilization process where solid or liquid chlorine is added to wastewater.

“Anaerobic digestion” means a process where oxygen is removed from wastewater such that bacteria can digest organics present in the wastewater.

### Water Reclamation, Filtration, and Return Process Water Reuse Applications

Embodiments of the present invention include a platform treatment system to treat wastewater from any application for reuse applications. The system optionally comprises one of the following systems: membrane based wash water recycling for laundry wastewater recycling, carwash wastewater recycling, wine water recycling, beer wastewater recycling, dairy water recycling, parts washing; membrane based wastewater recycling for biological digester effluent, cooling and boilers; membrane based wastewater recycling from washing parts, tanks, car, clothes, etc., or a system and process for recycling water comprising reclaim, filtration, and reuse, optionally where the waste is processed further and/or used for other applications. The system preferably comprises three subsystems: a reclaim subsystem, filtration subsystem, and return subsystem. The reclaim subsystem prevents wastewater from entering the filtration and return subsystems, which (i) may prevent those systems from operating properly, (ii) may damage those systems, (iii) will not or cannot be treated by those systems, or (iv) is not legally allowed to be treated from reuse. Examples of wastewater that cannot be treated include wastewater with more than 500 mV of oxidation potential, more than 2 ppm of free chlorine, with particles greater than 1″ in diameter, or which includes shirt collar stiffeners, buttons, and/or hangers. Difficult to treat wastewater includes wastewater above 105 degrees F. or wastewater from blackwater sources (which comprises animal waste). Examples of blackwater include sewage from toilets, sinks, and kitchens. For laundry wastewater treatment, this is preferably accomplished using four components. First one or more tanks are placed under the drain of washing machines. The tanks preferably drain into either another tank or into a drain. If multiple tanks are plumbed together, the lowest tank preferably comprises to have a drain. A pump is preferably placed at the lowest spot of tank or tanks (if multiple tanks are plumbed together). The pump can be but is not limited to a sump pump, an effluent pump, a sewage pump, or a well pump. The pump can be protected from large objects like bra wires, buttons, and collar stiffeners by a mesh, strainer, and/or filter screen. The opening size for the protective barriers is preferably greater than 0.04 inches and less than 2 inches. The pumps can be tethered to one or more probes that measure the quality of the wastewater. Probes can continuously measure water conductivity, turbidity, ion concentration, oxidation potential, turbidity, and/or other parameters. Alternatively, wastewater can be treated to meet the operating requirements of the system. In example, oxidation potential can be reduced to below 500 mV by dosing anti-oxidants such as sodium metabisulfite, temperature can be reduced using heat exchangers, and biologics (such as bacteria and virus) can be neutralized via a two step oxidation and oxidation neutralization process. In this invention, we show the correlation of turbidity and electrical conductivity demonstrating that conductivity can be used as an indirect measure of turbidity.

Embodiments of the present invention include pretreatment for the reverse osmosis membrane using a filtration step where the pores are less than 300 microns and greater than 5 microns. It is then preferably followed by a membrane treatment step where the membrane pore size is that of a microfiltration and/or ultrafiltration membrane (the pore size of microfiltration and ultrafiltration overlap sometimes) and the membrane configuration is tubular, hollow fiber (both inside out and outside in), or flat sheet with a through channel spacer. The membrane is preferably operated with a pressure delta across the membrane between 5.0 and 50 psi. The membrane is preferably cleaned by a combination of backflushing, backwashing, forward flushing and forward washing. At regular intervals the membrane is preferably brought out of operation for a clean in place (CIP) protocol. The CIP preferentially uses hydrogen peroxide to clean the membrane.

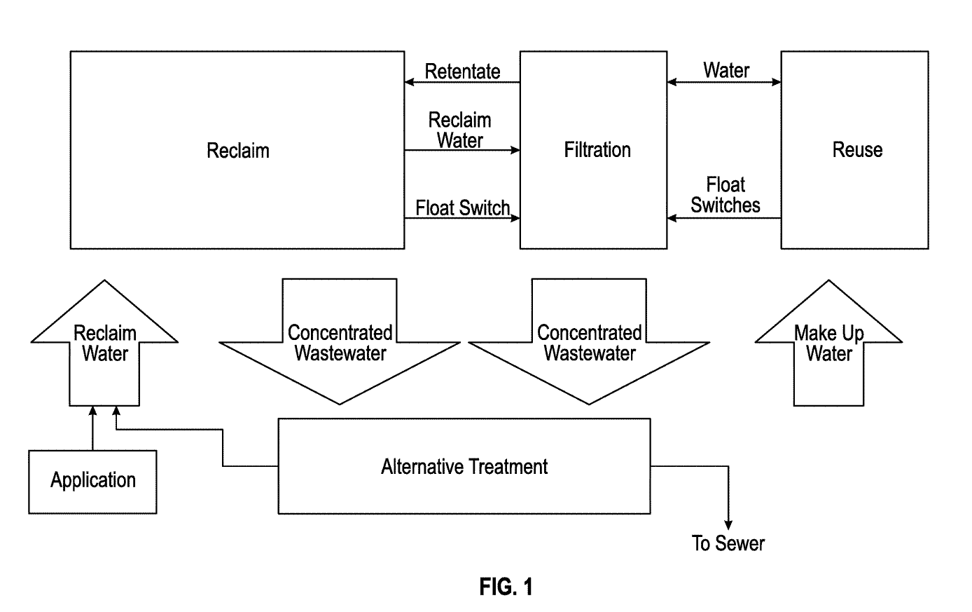

This invention preferably comprises a three step process to reclaim, filter, and reuse wastewater. The concentrated wastewater from the process can either be disposed of or treated using alternative methods. Desirable alternative methods include: oxidation, biological treatment, electro dialysis, straining, and filtration. The goal of alternative treatment can be, but is not limited to, treating the water so that it can be feed back into the process, storing and/or treating the water to be used for other applications, treating the water so that the high concentration waste is acceptable to dispose of, and/or disposing of the waste. For example, an alternative treatment may be a distillation process. For example, an alternative treatment may be a strainer bag that prevents large solids from entering into the sewer. FIG. 1 contains a process flow diagram of the three systems used to reclaim, filter, and return the wastewater as well as an alternative treatment. This NUF+RO (nano ultrafiltration plus reverse osmosis) system preferably minimizes the system footprint and thereby reduces shipping costs. A direct benefit is saving fresh or tap water by reusing wastewater for specific applications. The indirect benefits are the differences in physical properties between treated wastewaters and fresh or tap water. These properties include but are not limited to temperature, pH, alkalinity, hardness, and detergent concentration. Typically, the source of the wastewater has treated fresh or tap water to achieve one or more of these physical properties. By reusing the treated wastewater, energy, chemicals, and equipment costs may be reduced because the water is closer to ideal operating conditions. These physical properties are application specific and include, but are not limited to, the ability to remove or reduce existing potable water treatment and/or conditioning equipment, because the reuse water has already been treated and/or conditioned by this equipment. Such equipment, including chemicals and equipment that doses chemicals, can include water softening, water oxidizing, pH adjustment, and chemical addition such as water soluble wax and/or detergent.

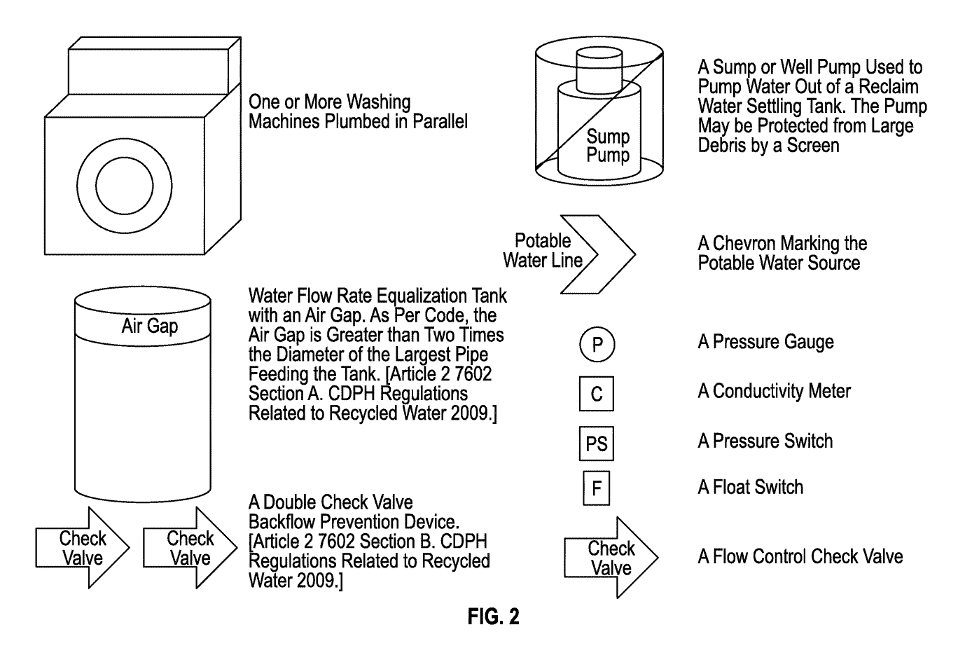

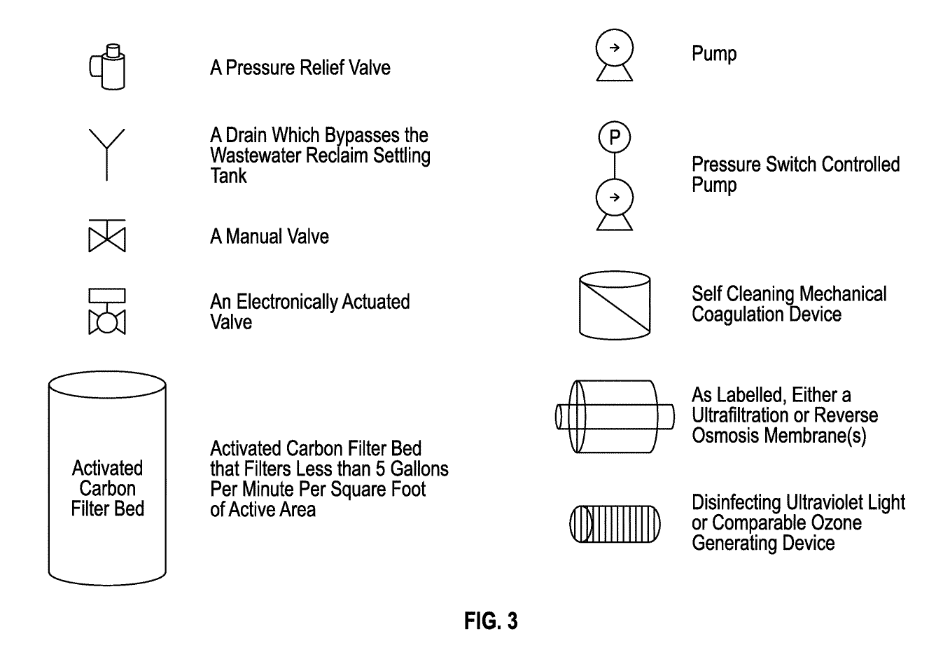

Specific water reuse applications that are relevant to this invention include, but are not limited to, recycling carwash wastewater, laundry wastewater, greywater, and blackwater. Greywater is non-putrescible wastewater. Blackwater is all wastewater, where greywater is a subset of blackwater. After treatment by this invention, approximately 10%-90% of the influent water has comparable or less total dissolved solids in comparison to potable water, meets disinfected tertiary treated wastewater standards, and can be used for primary applications. In some embodiments of this invention, the remaining water meets disinfected tertiary treated wastewater standards and can be used for secondary applications. When used in laundry applications, this invention can reduce laundry detergent consumption by approximately 10%-90%, and decrease water heating requirements by approximately 10%-90%. The primary water applications in laundry are all the wash cycles after the first cycle. The secondary application in laundry is the first wash cycle. This is because the surfactant concentration in the secondary application water is higher than the primary. Similarly, in carwash applications, the primary water applications are the final rinse of the car and chemical mixing. The secondary application of the water is prepping the car and wheel cleaning. Primary application water can always be used for secondary applications. Other applications of primary and secondary water include toilet flushing, irrigation, non-recreational impoundments, and cooling. FIGS. 2 and 3 both show piping and instrumentation diagram keys for the rest of the figures.

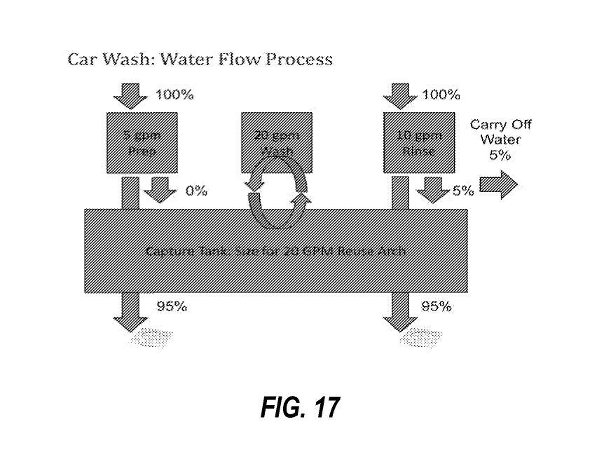

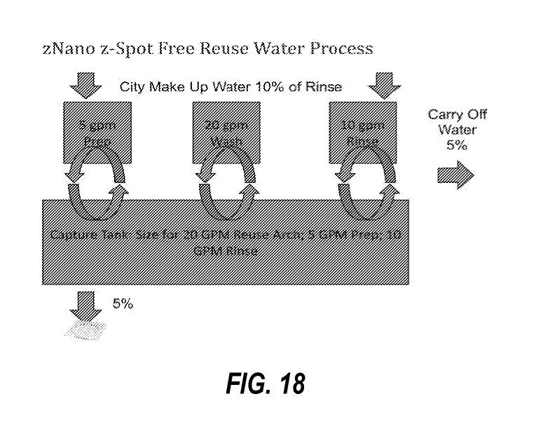

FIG. 17 shows typical carwash water use. As shown in FIG. 18, an embodiment of the present invention is a spot free reuse water treatment system that reuses water instead of using tap water to produce spot free rinse water. The Carwash Prep Step is the first step of the carwash process where cars are wetted and bulk debris is removed. Tap water is typically used for this step. The Carwash Wash Step is the middle step of the carwash process where reuse water cleans the car. Carwash Reuse water is the water collected from all steps of the carwash process that is reused in the Carwash Wash Step. The Carwash Rinse Step is the last step of the carwash where tap water or spot free water is used to rinse the car. Spot Free Rinse Water is softened water produced by reverse osmosis. Spot Free Rinse Waste is approximately 0.8-1.0 gallons of water waste produced when making 1 gallon of spot free rinse water. z-Spot Free Reuse Water is spot free rinse water produced from Reuse Water using the zNano process. Thus a water consuming step becomes a water saving technology, saving as much as $25,000 per year in water costs.

Reclaim sections of embodiments of the present system preferably comprise one or more of the following: one or more filters; filters before the pump are 300 microns or bigger; filters after the pump are 100 microns or smaller; and leaving the water in the reclaim tank for less than 24 hours, more preferably less than twelve hours, even more preferably less than six hours; and even more preferably less than two hours before it is removed.

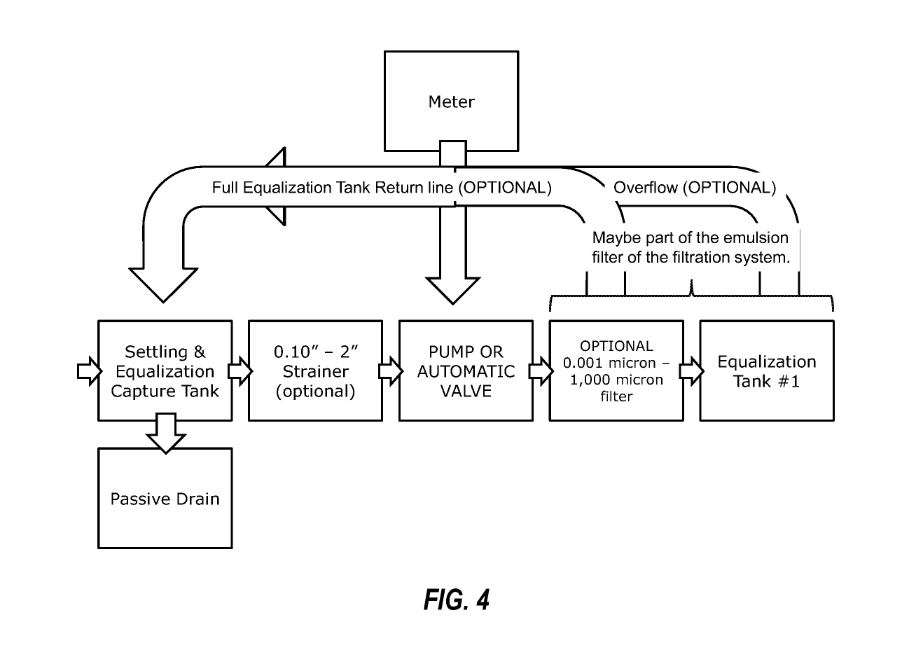

FIG. 4 contains a process flow diagram of each step in an embodiment of the water reclamation system. The first step is the capture of water in a dual function settling and load equalization tank. The wastewater falls through air allowing it to be oxidized. In some processes, the production of wastewater is intermittent. For example, washing machines produce wastewater only at the end of every cycle, roughly every 10-20 minutes. Carwashes produce wastewater every time a car enters the archway at an estimated ratio of 1 minute on for every 3 minutes off. In addition, various steps within the process may require differing amounts of water. Equalization tanks store the total volume of wastewater between each production event. Storing the wastewater is preferable because it minimizes the cost of the filtration step, because the rate of filtration needs only to meet or exceed the rate of the volume of water per event divided by the time between events instead of the volume of water per event divided by the length of time of the event. For example, a washing machine may produce 10 gallons of wastewater every 10 minute cycle, requiring a one gallon per minute filtration system with the equalization tanks. Without the equalization tanks, the washing machine would require a 10 gallon per minute system. The settling and equalization tank preferably comprises an overflow drain and a full drain at the bottom which is always open to prevent the accumulation of standing water.

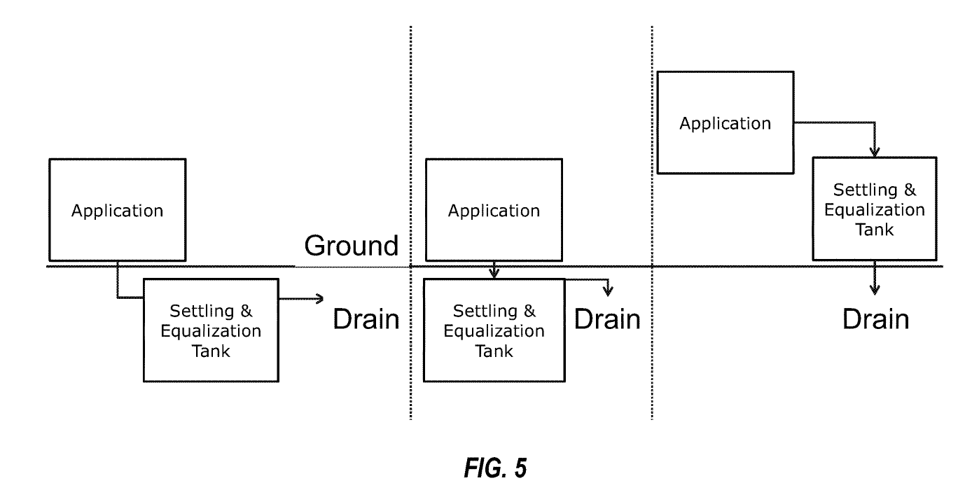

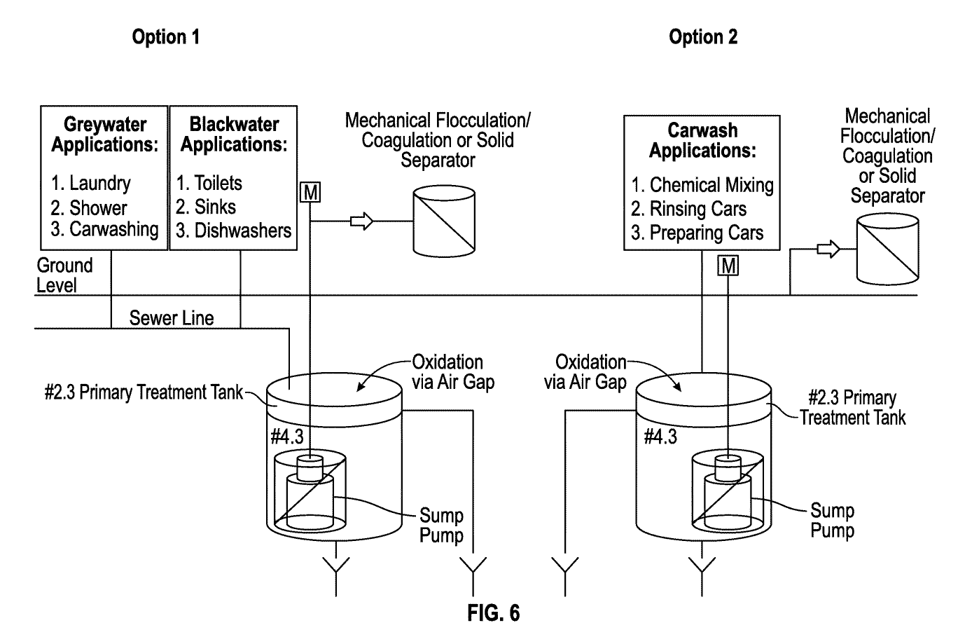

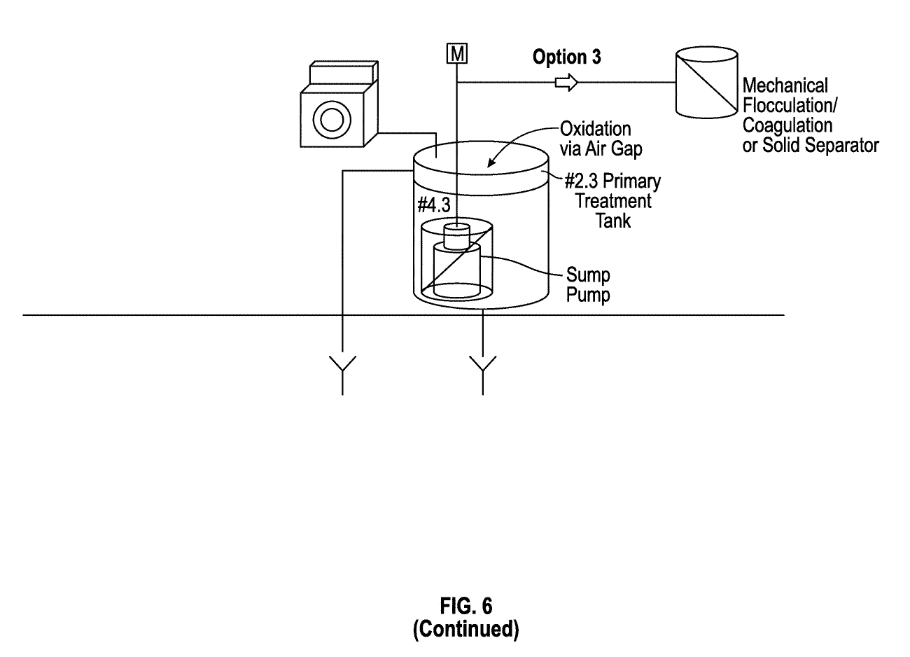

There are several different styles of wastewater capture tanks. FIG. 5 contains process flow diagrams and FIG. 6 contains piping and instrumentation diagram of various configuration options of settling and equalization tanks. Settling and equalization tanks can be plumbed to collect water from a sewer line as in option 1 of FIGS. 5 and 6. This is typical for blackwater applications, but is not limited to them. Option 2 in FIGS. 5 and 6 is a settling and equalization tank underneath the application that catches the wastewater. This is typical but not limited to carwash applications. Option 3 in FIGS. 5 and 6 is an above ground tank plumbed below the application. This is typical, but not limited to laundry applications where gravity drains are common.

Large particles and objects will settle out in the settling and equalization tank. In laundry applications, these objects may include shirt tags, buttons, and bra wires. In carwash applications, these objects may include dirt and car parts. In blackwater applications, these solids may include feces and toilet paper. As shown in FIG. 4, within the settling and equalization tank there may be a strainer with openings between 0.1″ and 2″. This strainer protects the inlet to the pump from large objects that have not settled out. The pump may be elevated from the bottom of the settling and equalization tank to reduce the intake of settled solids into the pump. The pump can be a well pump, a self priming pump, an effluent pump, a sump pump, or a sewage pump. The pump can be controlled by a float switch or a level switch. The pump may be plumbed into a storage tank or a treatment tank. An optional meter can be attached to the pump to prevent hazardous water from entering the filtration system. An optional meter can be attached to the treatment tank to prevent hazardous water from entering the filtration system. The meter can measure chlorine concentration, oxidation reduction potential, pH, electrical conductivity, temperature, turbidity, and/or other parameters. Treatment can include the addition of oxidation (e.g. for sterilization), anti oxidants (e.g. to protect the filtration system), and/or heat exchangers/chillers (to protect the filtration system). Wastewaters that can damage the filtration system include those comprising blackwater with high colony forming unit (CFU) counts, oxidation reduction potentials above 600 mV, chlorine concentrations above 1 ppm, temperatures above 113 Fahrenheit, pH above 11, and/or pH below 2. The meter can either turn off the pump or engage treatment processes that bring the wastewater to acceptable levels. Examples of treatment options include the addition of chlorine or equivalent oxidant to sterilize the wastewater, the addition of anti oxidants such as sodium metabisulfite to remove oxidants in the wastewater and/or oxidants added to sterilize the wastewater, the addition of acid or base to adjust the pH towards 7.0, the use of heat exchangers to decrease the temperature of the water, and/or the addition of tap water to decrease the temperature of the wastewater.

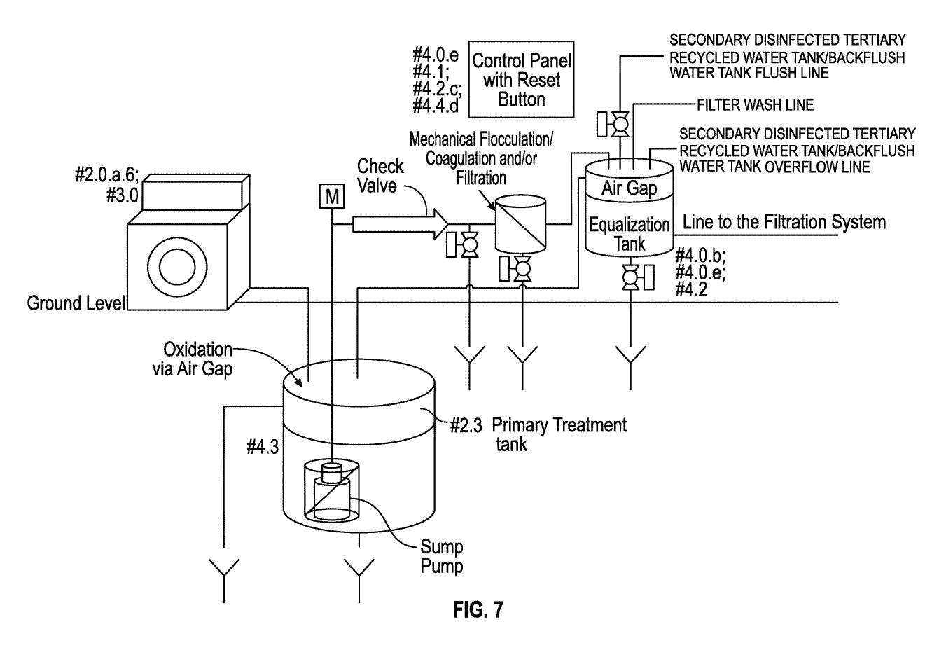

The pump preferably pressurizes the wastewater to pass through a filter, a strainer, a mechanical coagulator, a microfiltration membrane, an ultrafiltration membrane, or a spin disk in the filtration step. Spin disk filtration is preferable for lint removal in laundry systems. Spin disks typically have pores of approximately 32 microns or approximately 60 microns in size. For car wash applications, centrifugal solid separators are preferable. Solid separators may have integrated strainers, preferably comprising openings of approximately 75 microns or approximately 5 microns in size. A check valve, as shown in FIG. 7, prevents the backflow of water into the settling and equalization tank when the sump pump turns off. Without the check valve, the backflow of water may reactivate the pump if the pump is controlled by a water level sensor. The pore size of the filter can be between approximately 0.001 microns and 1000 microns. There may be more than one filtration step in series. The filter may comprise a pleated filter, a bag filter, a cartridge filter, or another type of filter. The strainer may be self cleaning. If the filter is an ultrafiltration or microfiltration membrane, it may be backwashable, in a spiral wound configuration, in a plate and frame configuration, in a hollow fiber configuration, and/or in a submerged configuration. The pore size of the membrane may be rated in molecular weight cutoff (MWCO). The MWCO may be as low as approximately 1,000 daltons. For laundry applications, the filter may be either lint permeable or lint impermeable depending on the requirements of both the first membrane and the first pump in the filtration step. Lint permeable filters have openings or pores greater than approximately 300 microns. Lint impermeable filters have openings or pores less than approximately 300 microns.

If the pore size of the filtration step is sufficiently small (typically less than or equal to 0.2 micron), it eliminates the need for the organic and emulsion removal step in the filtration system. The filter can be mechanically cleaned, chemically cleaned, or both. Cleaning can be actively initiated based upon time or inlet pressure. Cleaning can also be passive in which the filtration step is drained of water and the filtration step is cleaned by hand. The filtration step may have a flow return line to prevent over pressurizing the filtration step as it becomes less permeable. The filtration step may have either a passive or active drain to enable easy cleaning of the filter housing. After the filtration step, water is stored in an equalization tank. Pressure is prevented from accumulating in the equalization tank preferably either by active control tied to pump operation control (I.e. if the tank is full, the pump turns off) or by passive water return line to the settling and equalization tank. Active control is more preferable because it reduces the frequency of the cleaning of the filtration step. Passive control is more feasible because the pump can be located a long distance from the equalization tank. Active controls may include but are not limited to pressure sensors and level sensors. The equalization tank may also comprise an active or passive full drain valve to enable cleaning and to eliminate standing water.

The equalization tank preferably comprises a filter wash line for solutions used to recycle wash used to clean the membranes, a pump feed primary or secondary disinfected tertiary treatment recycled water line to fill the equalization tank during membrane cleaning, and an optional passive overflow line from the secondary disinfected tertiary treatment recycled water tank to prevent pressure accumulation in the secondary disinfected tertiary treatment recycled water tank. The passive overflow line may be plumbed to the settling and equalization tank instead of the equalization tank as shown in FIG. 7. From the equalization tank, there will be a feed to the filtration system. A sensor from the filtration system will be connected to the equalization tank or connected to a pipe directly connecting to the equalization tank to measure when water is present in the equalization tank. That sensor could but is not limited to be a level sensor, or a pressure sensor. In some embodiments of the invention, turbidity requirements are meet via indirect measurement. One such indirect measure is electrical conductivity since turbidity removal and electrical conductivity removal are correlated. Indirect measurements can be used for both primary and secondary applications. Electrical conductivity removal for primary applications is typically between approximately 40% and 90%. Electrical conductivity removal for secondary applications is typically between approximately 5% and 25%. Primary and secondary application water will preferably be stored in equalization tanks. These tanks have the same benefit as the equalization tank used for the reclaim water. Water from these tanks may be used for cleaning using an on demand pump (pressure switch controlled) and automatic control valves.

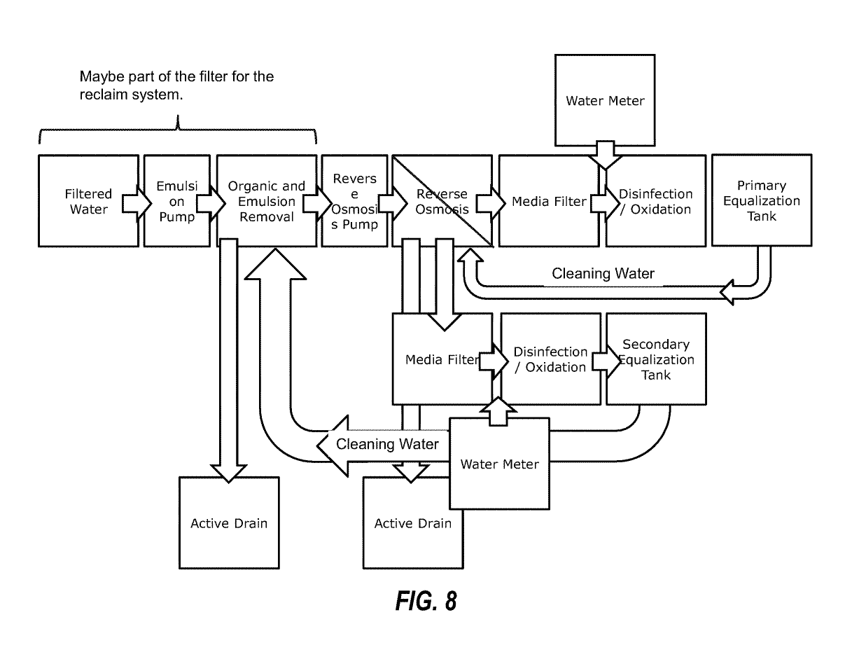

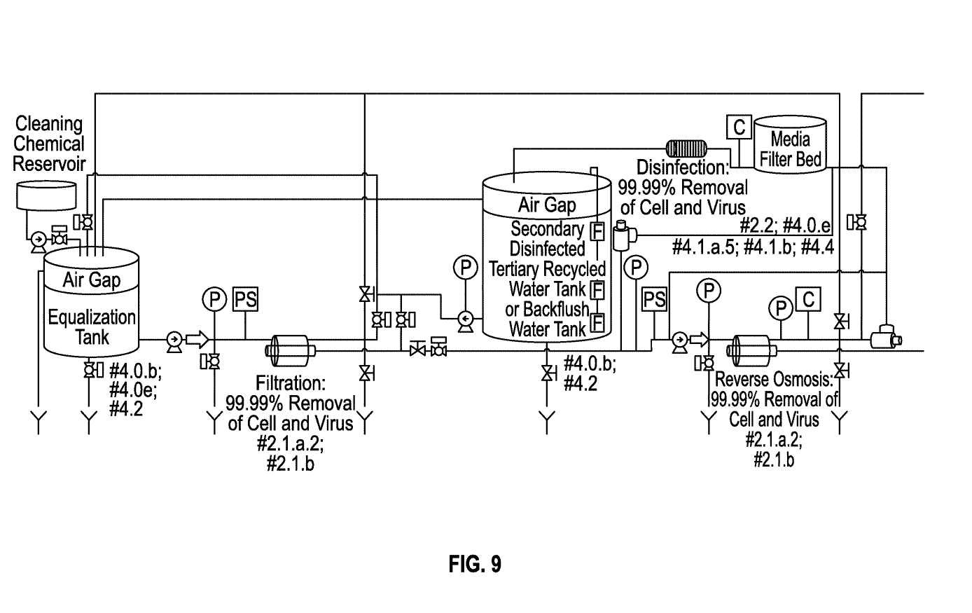

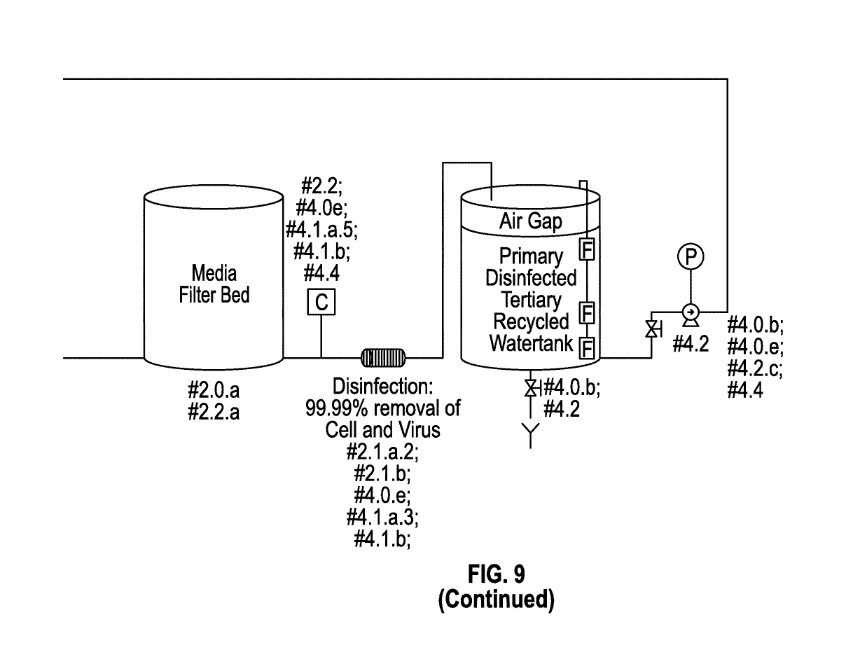

A process flow diagram of the filtration step is contained in FIG. 8 and a piping and instrumentation diagram is contained in FIG. 9. Specifically, filtered water from the reclaim system is passed into the filtration system. Sensors on the reclaim system preferably indicate that there is reclaim water to filter to control the first stage, the emulsion pump. Water is then filtered by the organic and emulsion removal stage. This stage removes solids, some organics, and emulsified oils. This stage preferably comprises a membrane. The membrane is preferably an ultrafiltration or microfiltration membrane. The pore size of this stage can be anywhere between or equal to approximately 1.0 nm and 300 nm. The pore size may be measured as MWCO. The MWCO can be anywhere between approximately 300 MWCO and 1,000,0000 MWCO. The membrane is preferably backwashable. If the membrane configuration comprises a spiral wound element, the spacer is preferably either biplanar or comprises through channels. Neither the pump or membrane are typically required if the filter in the reclaim stage is either a microfiltration or an ultrafiltration membrane that meets the pore size specifications of greater than or equal to approximately 1 nm and less than or equal to approximately 300 nm. Neither the pump nor membrane are typically required if the filter in the reclaim stage is either a microfiltration or an ultrafiltration membrane that meets the pore size specifications of greater than or equal to 300 MWCO and less than or equal to 1,000,000 MWCO.

The organic and emulsion removal stage preferably comprises active controls to both backwash and wash the membrane. The cleaning of the organic and emulsion removal step is preferably controlled by a pressure sensor before the step, a flow sensor behind the step, a flow sensor on the retentate from the step, a pressure sensor on the permeate from the step, and/or a timer. The membrane is preferably backwashed and washed with the secondary application water because the secondary application water contains unbound surfactant enhancing the cleaning process, and has fewer applications than the primary application water. If the organic and emulsion removal stage is not present because the pore size of the filtration step in the reclaim system meets the organic and emulsion removal criteria, then the secondary application water is preferably used to wash the filtration step in the reclaim process. In the case, the filtration step in the reclaim process may comprise all of the same valves that are drawn in the organic and emulsion removal stage in the filtration system. The organic and emulsion removal stage has manual valves and/or automatic valves to recirculate wash water back to the equalization tank and to drain wash water from the equalization tank for offline cleaning. For carwash applications, oxidants or other chemicals that dissolve wax such as degreasers containing buto-oxyethanol, isopropanol or similar molecules, may be added to the wash water to enhance the removal of wax. For laundry applications, detergents used to wash clothes may be added to the wash water to enhance cleaning of the membrane.

There is preferably an automatic control valve between the organic and emulsion removal stage and the reverse osmosis pump that closes when the organic and emulsion removal stage is being cleaned. The valve is open during filtration. The reverse osmosis pump is preferably controlled by a pressure switch or a flow switch on the permeate pipe from the organic and emulsion removal stage. The pressure between the stage may be limited by the inclusion of a pressure relief valve. If so, that water can be collected and treated with the secondary application water. If the organic and emulsion removal stage is part of the reclaim system, then the pressure switch is on the permeate pipe from the reclaim system. The reverse osmosis pump pressurizes the water to preferably between 120-300 psi. The water flows into a brackish water thin film composite reverse osmosis membrane spiral wound element in a reverse osmosis pressure vessel. The pressure vessel has manual valves that allow for the recirculation and draining of washwater for offline cleaning. Offline cleaning is preferential performed with acid and some surfactant for laundry applications.

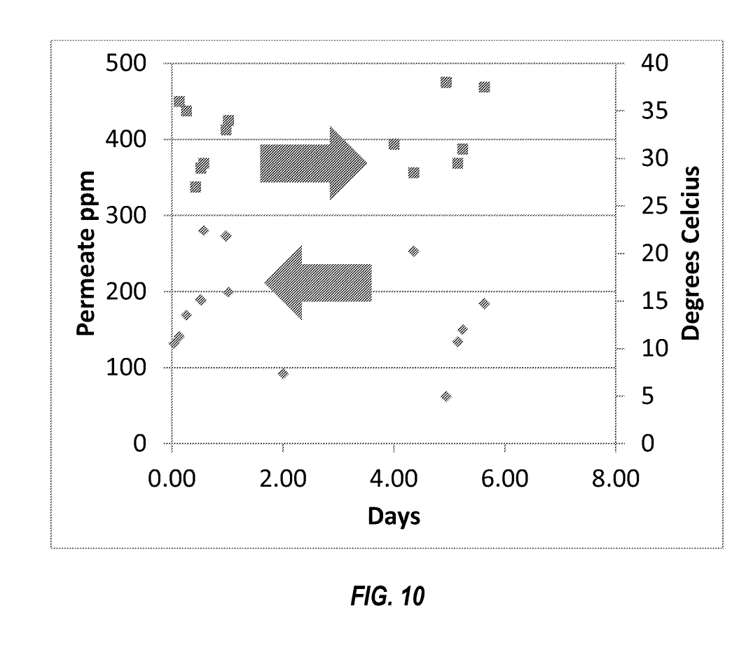

The reverse osmosis membrane preferably recovers 10% to 90% of the feed water. To increase recovery, retentate water from the reverse osmosis step can be recycled. To regulate the pressure on the reverse osmosis process, a pressure relief valve can be used as shown in FIG. 9. The reverse osmosis membranes can be plumbed in a Christmas tree configuration to increase water recovery. As shown in FIG. 10, the permeate water from a laundry process almost always contains less than approximately 300 ppm of total dissolved solids and contains on average less than approximately 200 ppm of total dissolved solids (TDS). Typically, feed water was between approximately 450 ppm and 1000 ppm. Higher concentrations of TDS in the permeate is typically indicative of fouling in the organic and emulsion removal step. TDS meters can be used to monitor fouling of that step where the feed water TDS should be approximately equal to or 20% greater than the filtrate TDS. Cleaning of the membranes is preferably controlled by the TDS measured in the permeate and/or the ratio of the TDS in the permeate to the TDS in the feed water. If the TDS levels become unacceptable, typically above 300 ppm, the reverse osmosis membrane is preferably automatically flushed with primary application water and the organic and emulsion removal step is backwashed with secondary application water. An optional step is to treat the retentate water for secondary applications. In addition, the average temperature of the water from the reverse osmosis step is typically 32 degrees Celsius in laundry applications. Because over the same period the tap water is was 21 Celsius, there is an energy savings from not having to heat the permeate water to above 35 Celsius for laundry applications. Table 1 shows measurements of the turbidity of the water after each stage of filtration. The turbidity of tap water is listed for comparison. As shown in Table 1, the turbidity of the permeate is below 2 NTU which meets the California Reuse water requirement for disinfected tertiary recycled water if the water is then filtered through a media bed in laundry applications.

TABLE 1

| WATER | TAP | RO | NUF |
|---|---|---|---|
| Turbidity | 0.16; | 1.09; | 7.11; |
| 0 min | 0.17; | 1.04; | 7.05; |
| (settled for >30 minutes) | 0.16 | 0.91; | 6.91 |
| Turbidity | | 1.03; | 7.29; |
| 3 min | | 1.01; | 7.25; |
| | | 1.01; | 7.23 |
| Turbidity | | 1.07; | 7.23; |
| 6 min | | 1.09; | 7.24; |
| | | 1.14 | 7.25 |

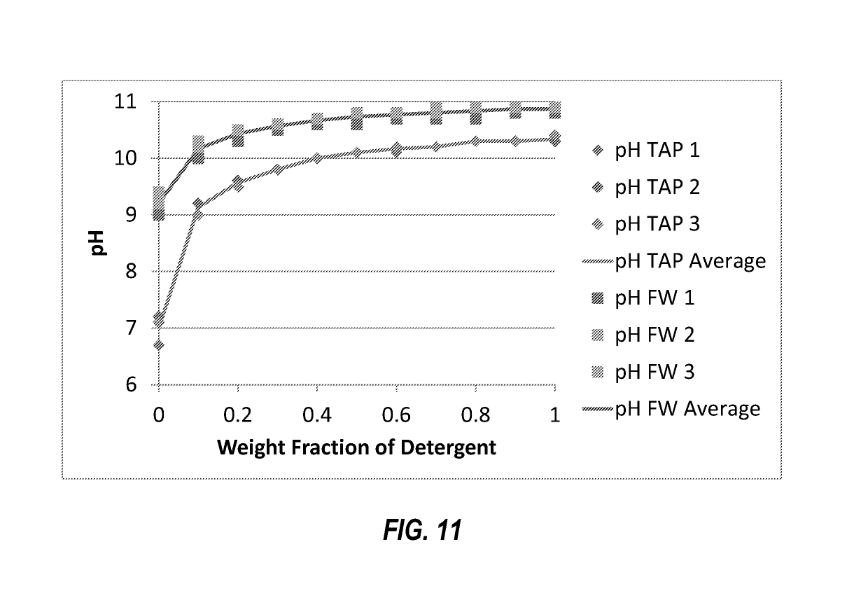

In FIGS. 8 and 9, there is a media bed filter after the reverse osmosis step to meet that requirement in laundry applications. A water meter preferably ensures that the water meets primary application reuse requirements, specifically any part of the laundry process, the carwash process, cooling, impoundments, or cleaning for example. That meter may measure TDS, turbidity, temperature, pH, flow rate or any other water quality parameter. The water from the organic and emulsion removal step, labeled NUF in the table, does not meet the requirement and may need subsequent treatment to remove turbidity sufficiently for it to be used for secondary applications. That optional treatment preferably comprises a media bed, preferably comprising activated carbon. A water meter ensures that the water meets secondary application reuse requirements. Secondary reuse applications include toilet flushing, cooling, wash cycles for laundry, wash cycles for carwashes, prep guns for carwashes, and water impoundments such as fountains. That meter may measure TDS, turbidity, temperature, pH, flow rate or any other water quality parameter. The water from the organic and emulsion removal step does not need additional treatment to be used to wash the organics and emulsion removal step. For both primary and secondary applications, the water requires disinfection before it can be used. That step can be ultraviolet light, ozone, or chemical oxidation via a metering pump as shown in FIGS. 8 and 9. Upon shutdown, the system preferably automatically cleans both filtration steps and may drain the secondary application reuse water if the disinfection step is not included in the process. All drains preferably have air vents to break siphons. Air vents are preferably plumbed to the ceiling or outside to prevent odor. The higher pH of the permeate water and the elimination of water hardness in laundry applications make the permeate water more responsive to detergent. FIG. 11 shows a titration of tap water and permeate (filtered) water with detergent. Data is shown in Table 2 below. The permeate water achieves a pH of 10 using about 75% fewer weight fraction units of detergent in comparison to the tap water. Because pH adjustment is a feature of detergent, this indicates detergent requirements of laundry applications could be reduced up to 75%. The higher turbidity of the filtered water from the organic and emulsion removal step suggests up to 10% recovery of unbound surfactant. Unbound surfactant could be further utilized to reduce detergent requirements in processes.

TABLE 2

| Weight Fraction | pH | pH | pH | pH | pH | pH |
|---|---|---|---|---|---|---|
| of Detergent | TAP 1 | TAP 2 | TAP 3 | FW 1 | FW 2 | FW 3 |
| 0 | 6.7 | 7.2 | 7.1 | 9 | 9.4 | 9.2 |
| 0.1 | 9.2 | 9.2 | 9 | 10 | 10.3 | 10.2 |
| 0.2 | 9.6 | 9.6 | 9.5 | 10.3 | 10.5 | 10.5 |
| 0.3 | 9.8 | 9.8 | 9.8 | 10.5 | 10.6 | 10.6 |
| 0.4 | 10 | 10 | 10 | 10.6 | 10.7 | 10.7 |
| 0.5 | 10.1 | 10.1 | 10.1 | 10.6 | 10.8 | 10.8 |
| 0.6 | 10.1 | 10.2 | 10.2 | 10.7 | 10.8 | 10.8 |
| 0.7 | 10.2 | 10.2 | 10.2 | 10.7 | 10.9 | 10.8 |
| 0.8 | 10.3 | 10.3 | 10.3 | 10.7 | 10.9 | 10.9 |
| 0.9 | 10.3 | 10.3 | 10.3 | 10.8 | 10.9 | 10.9 |
| 1 | 10.3 | 10.3 | 10.4 | 10.8 | 10.9 | 10.9 |

The total dissolved solids (TDS) of the effluent will be continuously monitored to ensure the filtration process is functioning properly. TDS is a higher standard than turbidity. The TDS of the disinfected tertiary recycled water will be less than 200 ppm at all times. The average TDS of tap water in San Jose is between 220 and 422 depending on the water source (2012 Water Quality Report, San Jose Water Company, reproduced in Table 3 below). In pilot testing, we have shown that the system produces water with a turbidity below 2.0 NTU when the TDS of the water is below 200 ppm.

Below is data showing that requiring the filtered water to have less TDS than the TDS of average tap water is a higher standard than is required for disinfected tertiary recycled water. The turbidity requirement for disinfected tertiary recycled water is <2.0 NTU. The data in Table 4 shows that the turbidity (NTU) of tap water is <0.3 NTU (2012 Water Quality Report, San Jose Water Company). In comparison, the system will only recycle water if the TDS is below 200 ppm. The average tap water in San Jose has average TDS of 220, 279, or 422 ppm depending on the source. This data demonstrates that the requirement for disinfected tertiary recycled water is not as strict as tap water. Therefore, if the standard for the water produced by the filtration process is higher than tap water, then the standard for the filtration process is higher than the turbidity requirement for disinfected tertiary recycled water.

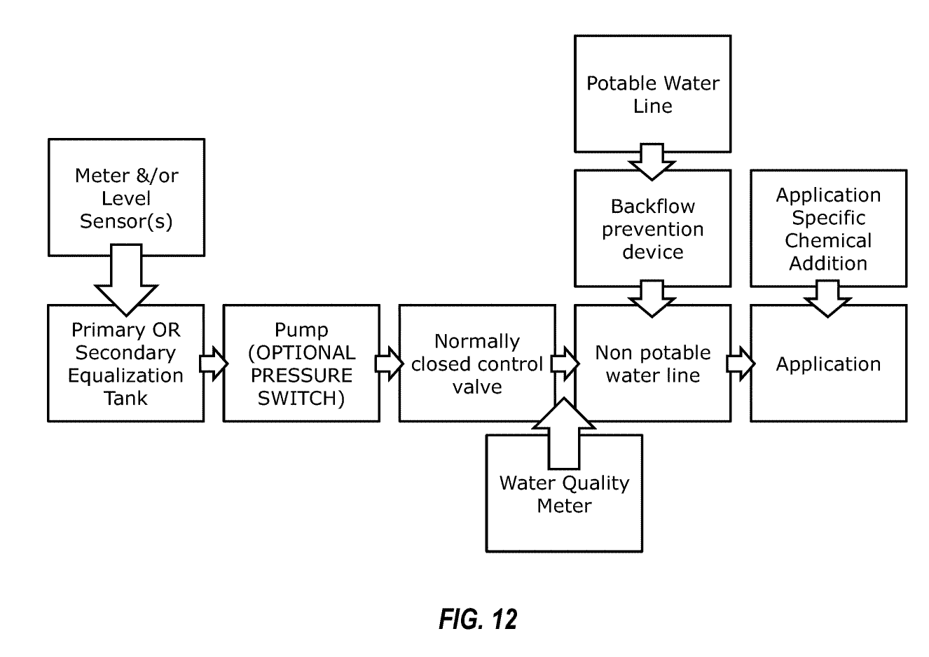

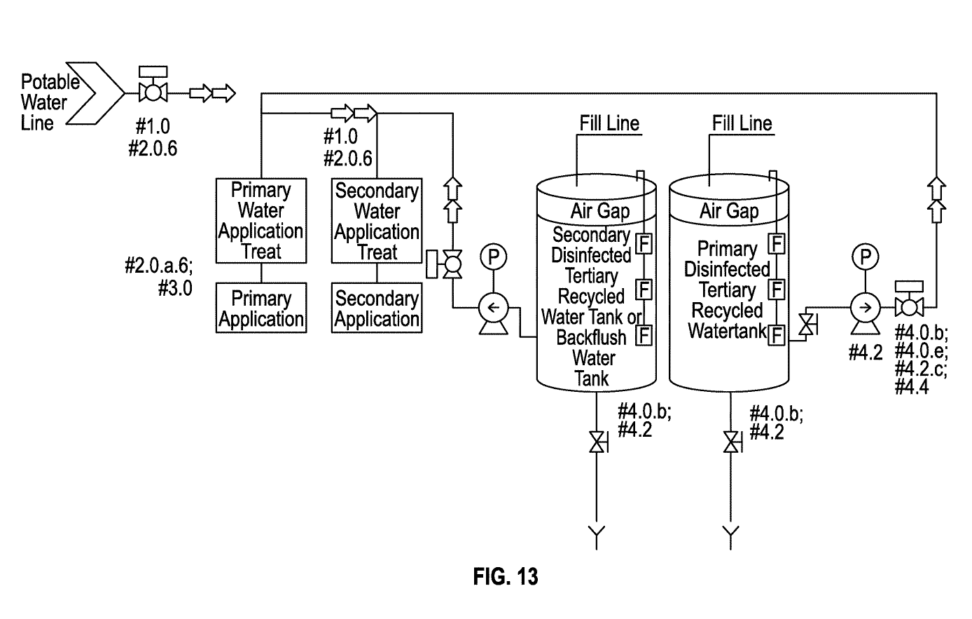

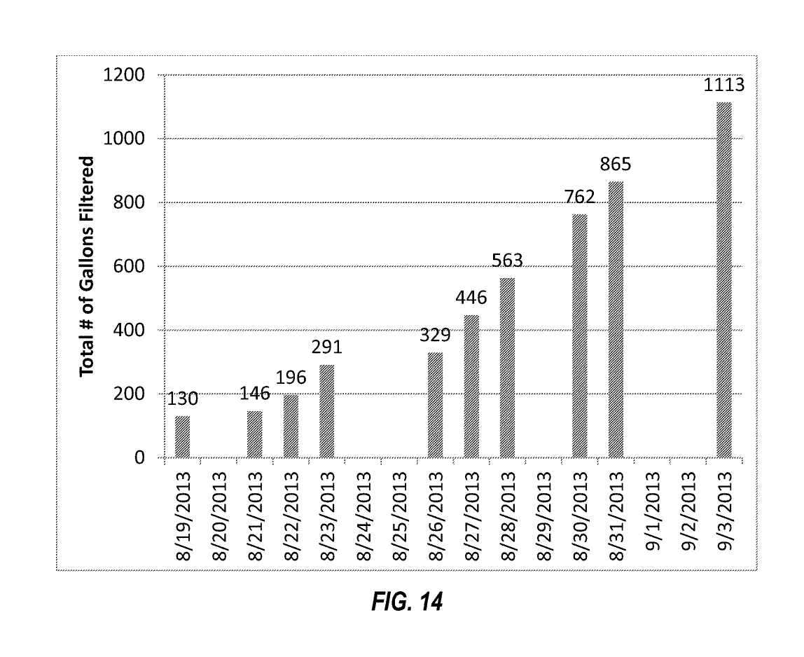

FIG. 12 is a process flow diagram of the return system for both the primary and secondary applications. Water is returned to the desired application via a pump which over-pressurizes the water from the equalization tanks into the non-potable water line. By default, the valve connecting the equalization tank and the non-potable line is closed to prevent contamination of the non-potable line if the water is not of sufficient quality for reuse. A water meter is preferably used to measure performance of the system and provide feedback which can indicate leaks. If the primary application tank is full, a signal is preferably sent to the filtration system to turn off. The water level is measured in the primary application tank via float switch or level meter. There are three level switches in the primary tank. The highest level is full, which turns the system off. The middle level is application ready, which open the normally closed control valve. The bottom level is empty, which either shuts the system off or opens a valve to fill the tank with water from the non potable water line. The secondary application tank has the same float switches, but the highest float switch preferably does not turn the filtration system off. Instead it either partially drains the tank or does nothing. Potable water coming into the non-potable water line preferably goes through a double check valve backflow prevention device as drawn in FIGS. 12 and 13 to prevent cross contamination of the potable water line. The final step of the invention can be an application-specific water treatment, such as chemical addition, detergent addition, water softening, and/or oxidant addition, to make the primary or secondary application water suitable for that specific application. The final step may be controlled by flow sensors, pressure sensor, or meter. FIG. 14 shows a plot of water reuse data from this invention recycling laundry water over a 15 day period. All of the reuse water was below 300 ppm of TDS. In case water for either the primary or secondary application does not meet the requirements for reuse, and alarm will be activated and the water will be automatically disposed of to the drain. The alarm will preferably need to be manually reset.

Embodiments of the present invention preferably successfully operate without the need to use a membrane bioreactor. Embodiments of the present invention preferably comprise the use of pressure feedback to control cleaning and detergent dosage. Embodiments of the present invention preferably comprise systems comprising a media filter which can successfully clean and reuse wastewater, blackwater, etc. as described herein.

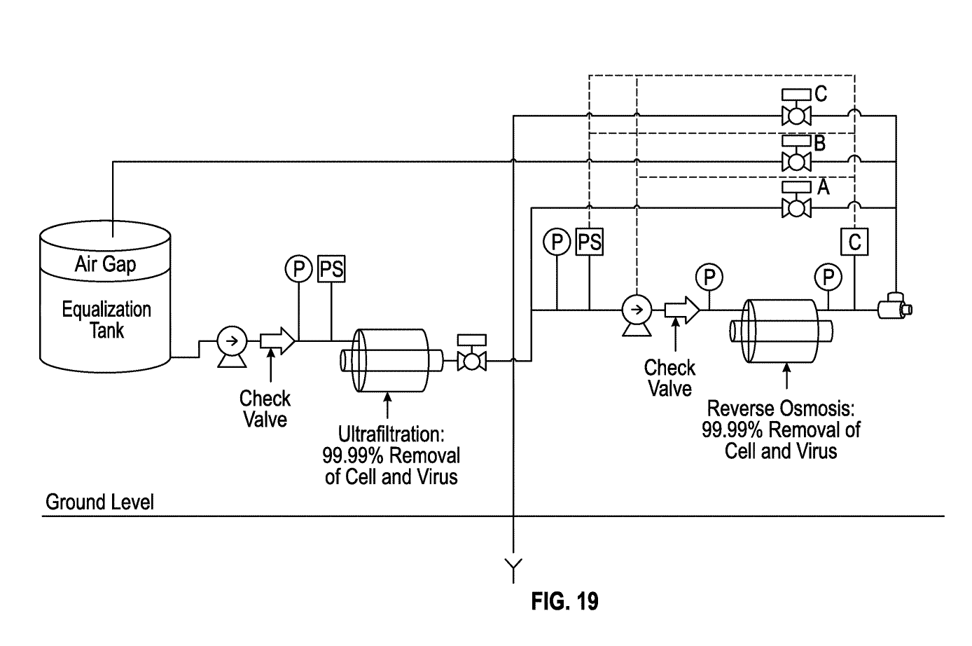

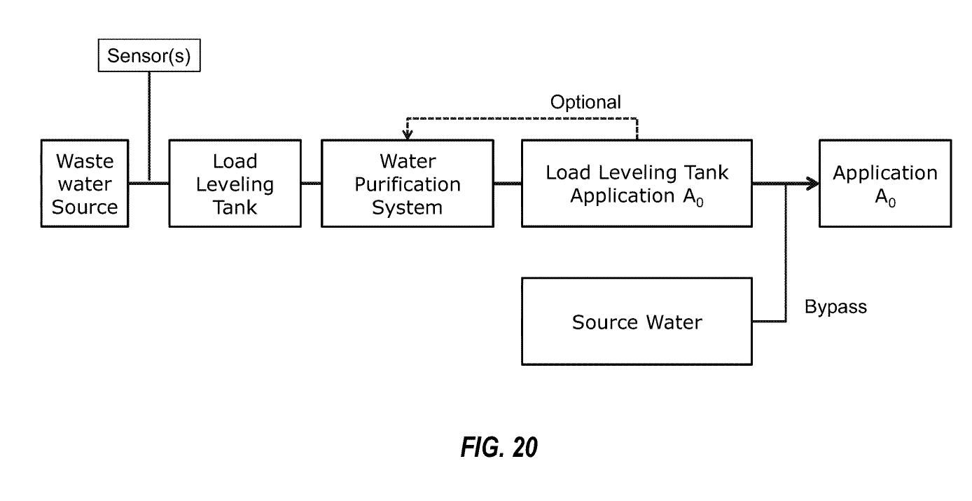

Several preferable features of the present invention enable the long term performance of membranes, media filters, and UV lamp. These features include backwashing, backflushing, and flushing of membranes to remove concentration polarization. On the pressure side of the pumps feeding the membranes, one or more detergent injection ports can be included such that detergent is injected immediately before the membrane enabling efficient detergent use and maximum effectiveness. On the retentate side of the membranes, several options are present for waste streams. FIG. 19 shows an example of retentate wastewater sorting. First, pressure is applied to the membrane via a flow restricting device such as a small pipe, a pressure relief value, a flow restrictor or a valve. After the device, water is sorted using control valves. There are three options: the first option (labeled valve A) is a water recycling pipe that leads back to the pump, the second option (labeled valve B) is a water draining pipe that leads back to the reclaim tank/equalization tank, and the third option (labeled valve C) is a water draining pipe that removes the water from the system. The amount of water allowed to pass through valve A can control the pressure of the system. Valve B can be used to recover concentrated detergent or other cleaning molecules from the RO and reuse them to clean the UF. Valve C preferably sends the water to the drain. In some embodiments of the invention, valve C removes the water from the system by sending it to other treatment (such as media filtration, and/or oxidation) for reuse in other applications. For example, in carwashes, water from valve C could be used to prep cars, and/or wash cars. In industrial laundries, water from valve C could be used in the first pocket of a tunnel washer to wet clothes or in the first cycle of a washing machine. The sorting preferably comprises three steps. The first step is open a valve (A) to recycle the retentate of RO process by plumbing the water back to the inlet of the pump. If the pressure on the inlet exceeds a range of acceptable values, a second (B) valve can be opened to recycle the retentate back to the Equalization Tank #N where N is the highest value of N in the system. Typical influent water is between 200-2,000 ppm of total dissolved solids (TDS). In some embodiments of the invention, brackish water RO membranes are employ which are rated to handle 2,000 ppm of TDS. In some embodiments of the invention, seawater RO membranes are employ which are rated to handle 35,000 ppm of TDS. If the TDS of the retentate exceeds an acceptable range, then a valve is opened to drain the retentate. The recycle drain may be closed when the TDS exceeds acceptable levels. One condition where the valve would be closed is when the TDS has exceeded acceptable levels for a long time, i.e. one or more minutes; one or more hours.

Filtration systems may comprise any of the following: single pipe (i.e. not requiring an equalization tank between the MF or UF filter and the RO filter) MF/UF/RO; single pipe MF/UF/RO/media filter for high turbdity/water reuse; single pipe UF/RO/media filter for high turbdity/water reuse; single pipe MF/RO for high turbdity/water reuse; single pipe MF/UF for high turbdity/water reuse; using RO as a media filter pretreatment to meet California Title 22 requirements (i.e. wherein the media filter requires <2 NTU of turbidity and the MF/UF/RO membrane has <0.2 NTU of turbidity); MF/UF/RO membranes are used as pre-treatment to minimize fouling of a media filter; addition of base to adjust wastewater to 7.0<pH<11.0 to decrease fouling; MF/UF/RO having >80% recovery; simultaneous flushing to increase cleaning efficiency; detergent injection into the UF and RO feeds; MF/UF permeate pressure switch activation of the RO pump, eliminating need for an intermediate equalization tank; MF/UF feed pressure switch, or alternatively timer, activation of MF/UF backwash; dumping of RO retentate at high TDS to reduce solute buildup; dumping of RO retentate when activated by RO feed pressure switch; and no biological, denitrification, oxidative or reductive pretreatments while still minimizing fouling and odor. In some of these embodiments the media filter may be used solely to reduce turbidity.

For water recycling and reuse applications, the treatment process may have to meet specific criteria. The water may need to be settled, oxidized, coagulated, passed through a filter bed then disinfected. In some embodiments of the present invention, water is passed through a filter bed comprising a media filter (0.1-1 micron nominal pore size) followed by disinfection by UV light, ozone, chlorine, and/or hydrogen peroxide. For chemical disinfection, dosing of the chemical agent is preferably controlled using an electronic meter. For electrochemical methods such as ozone and UV light, an alarm is preferably included to constantly monitor the quality of the disinfection.

The requirements for water reuse are typically strict. Water can be filtered, only if its turbidity is below 2 NTU. To reduce influent turbidity, a pretreatment process of MF+UF, MF+RO, UF+RO, or MF+UF+RO is preferably used upstream of the media filter. This treatment process reduces the turbidity of the wastewater such that it can be filtered by a media filter. A typical media filter requires the turbidity of the influent to be less than 5 NTU. The UF+RO process preferably reduces the turbidity to 1+/−0.15 NTU. This is below 2 NTU, which is the requirement for the water treated by the media filter. FIG. 8 is one example diagram of this invention. An ultrafiltration membrane and a reverse osmosis membrane are used as pretreatment to a media filter and a UV disinfection light (or alternately ozone or chlorine). The turbidity of the permeate from the reverse osmosis membrane is below 2 NTU ensuring low pressure drop through the media filter and removing iron and other solutes to enable high performance form the UV light. The flow rate through the media filter is preferably between 1.0 and 3.0 gallons per minute of flow for each 1.0 square foot of media filter surface area.

Systems comprising MF and/or UF treatment before RO may comprise one or more of the following: lowest energy wastewater RO process (inverse pressure curve), compressible cake removal, higher pressure required to compress the cake, 2× flat sheet surface area, retention of organics such as surfactants; plugging prevention using a sub-100 micron prefilter and/or an open channel/hollow fiber membrane; operation below 30 psi and above 10 psi; and/or flow restriction between UF and RO.

Embodiments of the present invention may include one or more of the following: batch wastewater treatment including storage of water for treatment for only 0.1-4.0 hours; lossless MF & UF backwashing; addition of >20 ppm surfactants to wastewater to increase flux; addition of 10 ppm-100,000 ppm surfactant to emulsify wastewater; minimizing organic fouling; backflushing; the MF filter does not remove organic compounds and prevents complex fouling; treating and reusing up to 100% of wastewater using reverse osmosis or forward osmosis; using the retentate of wastewater treated by the osmosis process for a separate application; separating water and molecules for distinct applications after the wastewater is filtered; the process is not limited by osmotic potential; measuring the concentration of molecules as part of the sorting process; a process where the amount of water processed to separate the desired solutes is equal to or less than the amount of water processed by the reverse osmosis step; and/or using the hydraulic pressure of the retentate to filter the wastewater.

Embodiments of the present invention comprise only requiring one pump to perform multiple filtration steps, preferably including one or more of the following: the filter pore size increases post the reverse osmosis step; the concentration of molecules are measured as part of the sorting process; the molecules are emulsified surfactants; the separated molecules are used to wash the membranes and various components within the wastewater treatment system; the membranes are washed using activated control valves activated by pressure sensors, timers, counters, and/or software; a tank is used to store water removed after Pump Stage N which is then used to “load level” the high instantaneous demand for of separate applications with the lower rate of volume of water processed by the wastewater treatment system; using the treated wastewater as fresh water but automatically bypassing that when no treated wastewater is available.

Embodiments of the present invention comprise reducing the use of detergent, including one or more of the following: removing 99% of solids, organics, multivalent ions, pH buffering ions and turbidity while retaining the pH within one pH unit; the maintenance of pH and/or the removal of multivalent ions, pH buffering ions, reduces the amount of chemicals needed to treat freshwater relative to the existing freshwater source; the amount of laundry or other detergent required is reduced by 20%-50%; preventing oxidizing wastewater from entering the process; preventing wastewater with oxidation reduction potential greater than 500 mV from entering the process; including two filtration steps and a separation step; including a final oxidation step; maintaining the pressure at one or more pump stages using a pressure release valve; operating two pumps together using pressure sensing; more than 0% and less than 100% of the filtered water is removed after Pump Stage i for an application such as washing one or more components in the process; both a membrane element and a strainer are backflushed simultaneously; using tanks to “load level” the high instantaneous volume of wastewater with the lower rate of volume of water processed by the wastewater treatment system; using tanks to “load level” the high instantaneous demand of fresh water by an applications with the lower rate of volume of water processed by the wastewater treatment system; enabling treated wastewater to be used as fresh water but is automatically bypassed when no treated wastewater is available; the wastewater source is from a municipal source, a well, a water treatment system, a laundry machine, a water reclaim tank, an industrial process, a commercial process, a commercial washing process, parts washing, or a carwash; and/or the wastewater source contains more than 10 ppm of surfactants.

One process of the present invention is as follows:
Drain of Reclaim Tank
Flush/Backflush/Backwash Membrane
Refill with detergent and purified water
   15 gallons per 5 4″ elements/1 8″ element
Recirculate detergent water for 3-20 minutes
   Optional heating
   Cleaning effectiveness is indirectly measured via recirculation pressure
Drain tank by opening valve
Flush membrane with 1×-3× wash volume
   Can be accomplished via backflush (water flowing in the opposite direction of filtration but not through the membrane)
Backflush or backwash
   Backflush (def)—water flowing in the opposite direction of filtration but not through the membrane
   Backwash (def)—water flowing in the opposite direction of filtration and through the membrane
Cleansers for Laundry include:
   Commercial detergents such as Tide for the UF membrane
   Commercial antiscalants such as CLR for the RO membrane

### Other Systems for Filtration of Wastewater

An embodiment of the present invention is a system used to treat water that includes one or more membrane filtration steps where the membranes in the system are at least partially comprised of sol-gel materials. For water treatment, the system preferably comprises two steps: a pretreatment step and a desalination step. The pretreatment step preferably removes solids and more than 80% of turbidity. The desalination step removes more than 50% of salinity. Either one or both membranes can be derived from sol-gel precursors and preferably include stabilized surfactants and/or are stabilized surfactant mesostructures or membranes. These membranes, which are used as filters and preferably comprise sol-gels, surfactants, or both are referred to herein as AM, or advanced membranes. The Recovery Percentage is the ratio of treated water to input water. The following tables are symbol keys for the elements in the following process flow diagrams (PFDs), which are specific, non-limiting embodiments of PFDs in accordance with the present invention.

TABLE 5
ACTIVE COMPONENTS

| Symbol | Active Components |
|---|---|
| 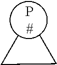 | Pump ID # in example: Transfer, Well, Booster, |
| | Sump Pump |
| 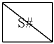 | Strainer ID# |
| 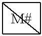 | Membrane ID # in example: Microfiltration |
| | Ultrafiltration |
| | Nanofiltration |
| | Reverse Osmosis |
| 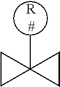 | Pressure Relief Valve ID # |
| 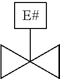 | Electronically Controlled Valve ID # in example: Butterfly, globe, soleniod |
| 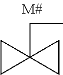 | Manual Valve ID# |
| 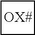 | Oxidation Step ID# in example: Ultraviolet disinfection |
| | Ozone |
| | Chlorine (chemical) |

TABLE 6
PASSIVE COMPONENTS

| Symbol | Passive Components |
|---|---|
| 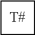 | Tank ID# |
| 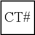 | Chemical Storage Tank ID# examples: pH modifiers, antiscalants, antioxidants antimicrobials |
| 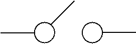 | Check Valve |
| 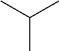 | Drain |
| | Pipe |
| ————— | Electrical Connection |

TABLE 7
SENSOR COMPONENTS

| Symbol | Sensor Components |
|---|---|
| 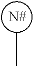 | A sensor ID# which senses: P: pressure C: conductivity F: Flow Meter or Fluid Level |
| | O: Oxidation/Reduction Potential |
| | pH: pH level |

The following is a process flow diagram (PFD) of a passive water treatment system incorporating AMs. Water is filtered through up to three AMs. After treatment with the AMs, water may be oxidized by the inclusion of an oxidation step.

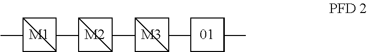

Below is a process flow diagram of a active water treatment system incorporating AMs. Water is filtered through up to three AMs. The final AM desalinates the water resulting in fractional treatment of the water. Classically, this is measured as water recovery percentage, the ratio of treated water to input water. After treatment with the AMs, water may be oxidized by the inclusion of an oxidation step. The pressure from booster pump P1 is regulated using relief valve R1.

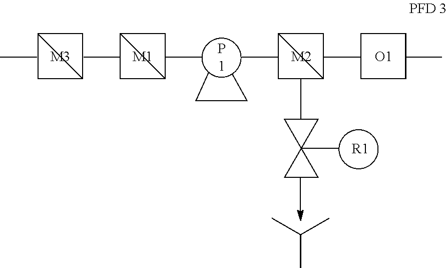

Below is a process flow diagram of a active water treatment system incorporating AMs that has active controls. Water is filtered through up to three AMs. The final AM desalinates the water resulting in fractional treatment of the water. Classically, this is measured as water recovery percentage, the ratio of treated water to input water. After treatment with the AMs, water may be oxidized by the inclusion of an oxidation step. The pressure from booster pump P1 is regulated using relief valve R1. Pressure sensors (P1, P2, and P3) regulate the wash cycle(s) of the system. Wash cycles can include via flushing, backflushing, reducing of pressure, increasing of flow rate, the introduction of chemicals or any combination thereof. When the pressure is greater than a set point, one or more wash cycles begins. Proper operation of the system is maintained via conductivity sensors (C1, C2, C3, and C4). The complete operation of the system is controlled by flow meters and/or fluid level sensors (F1, and F2).

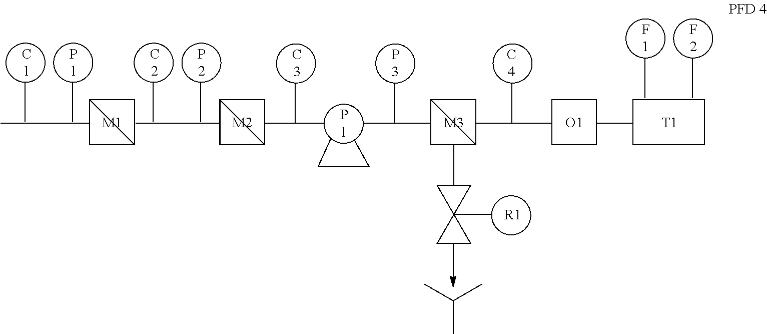

Below is a process flow diagram of a active water treatment system incorporating AMs that has active controls. Water is filtered through up to three AMs. The final AM desalinates the water resulting in fractional treatment of the water. Classically, this is measured as water recovery percentage, the ratio of treated water to input water. After treatment with the AMs, water may be oxidized by the inclusion of an oxidation step. The pressure from booster pump P1 is regulated using relief valve R1. Pressure sensors (P1, P2, and P3) regulate the wash cycle(s) of the system. Wash cycles can include via flushing, backflushing, reducing of pressure, increasing of flow rate, the introduction of chemicals or any combination thereof. When the pressure is greater than a set point, one or more wash cycles begins. Proper operation of the system is maintained via conductivity sensors (C1, C2, C3, and C4). The complete operation of the system is controlled by flow meters and/or fluid level sensors (F1, F2, and F3). Chemical dosing from CT1 via pump P2 is controlled via oxidation reduction potential sensor O1. In the process flow diagram (PFD), chemical dosing is representative. In the process flow diagram it occurs BEFORE M1 and M2, but it may occur in a different location. The invention includes chemical dosing after M1 and M2. It also includes more than one chemical dosing step. In example, the chemical dosing of antioxidants before M1 and shown in the PFD and the chemical dosing of antiscalants before M3. Chemical dosing of antiscalants is controlled using a pH sensor before P1 and after M2 which is not shown in the PFD. PFD 5 is the same PFD as PFD 4 with the addition of a transfer or sump pump, P4 that supplies water to the water treatment train.

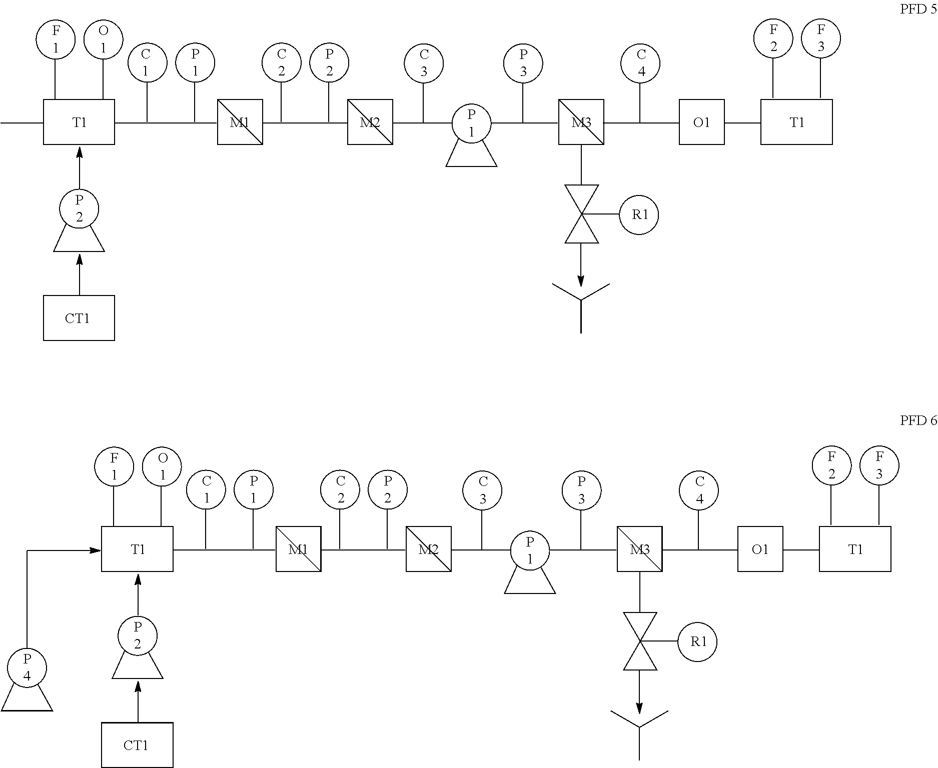

Below is a process flow diagram of a active water treatment system incorporating AMs that has active controls. Water is filtered through up to three AMs. The final AM desalinates the water resulting in fractional treatment of the water. Classically, this is measured as water recovery percentage, the ratio of treated water to input water. After treatment with the AMs, water may be oxidized by the inclusion of an oxidation step. The pressure from booster pump P1 is regulated using relief valve R1. Pressure sensors (P1, P2, and P3) regulate the wash cycle(s) of the system. Wash cycles can include via flushing, backflushing, reducing of pressure, increasing of flow rate, the introduction of chemicals or any combination thereof. When the pressure is greater than a set point, one or more wash cycles begins. Proper operation of the system is maintained via conductivity sensors (C1, C2, C3, and C4). The complete operation of the system is controlled by flow meters and/or fluid level sensors (F1, F2, and F3). Chemical dosing from CT1 via pump P2 is controlled via oxidation reduction potential sensor O1. In the process flow diagram (PFD), chemical dosing is representative. In the PFD, chemical dosing occurs BEFORE M1 and M2. The invention may also include chemical dosing after M1 and M2. It also includes more than one chemical dosing step. For example, the chemical dosing of antioxidants before M1 and shown in the PFD and the chemical dosing of antiscalants before M3. Chemical dosing of antiscalants is controlled using a pH sensor before P1 and after M2 which is not shown in the PFD. Before filtration by all of the membranes, water is filtered by strainer 1 in PFDs 6 and 7. Before filtration by all of the membranes, water is filtered by strainer 1 and strainer 2 in PFDs 8 and 9. In PFDs 6-9, the geometry of the tanks and the strainers allows for gravity driven backwashing of the strainers via the opening of an electronically controlled valve as shown in PFD 9. PFDs 7 and 9 are the same as PFDs 6 and 8 respectively with the addition of a transfer or sump pump P4 that supplies water to the water treatment train.

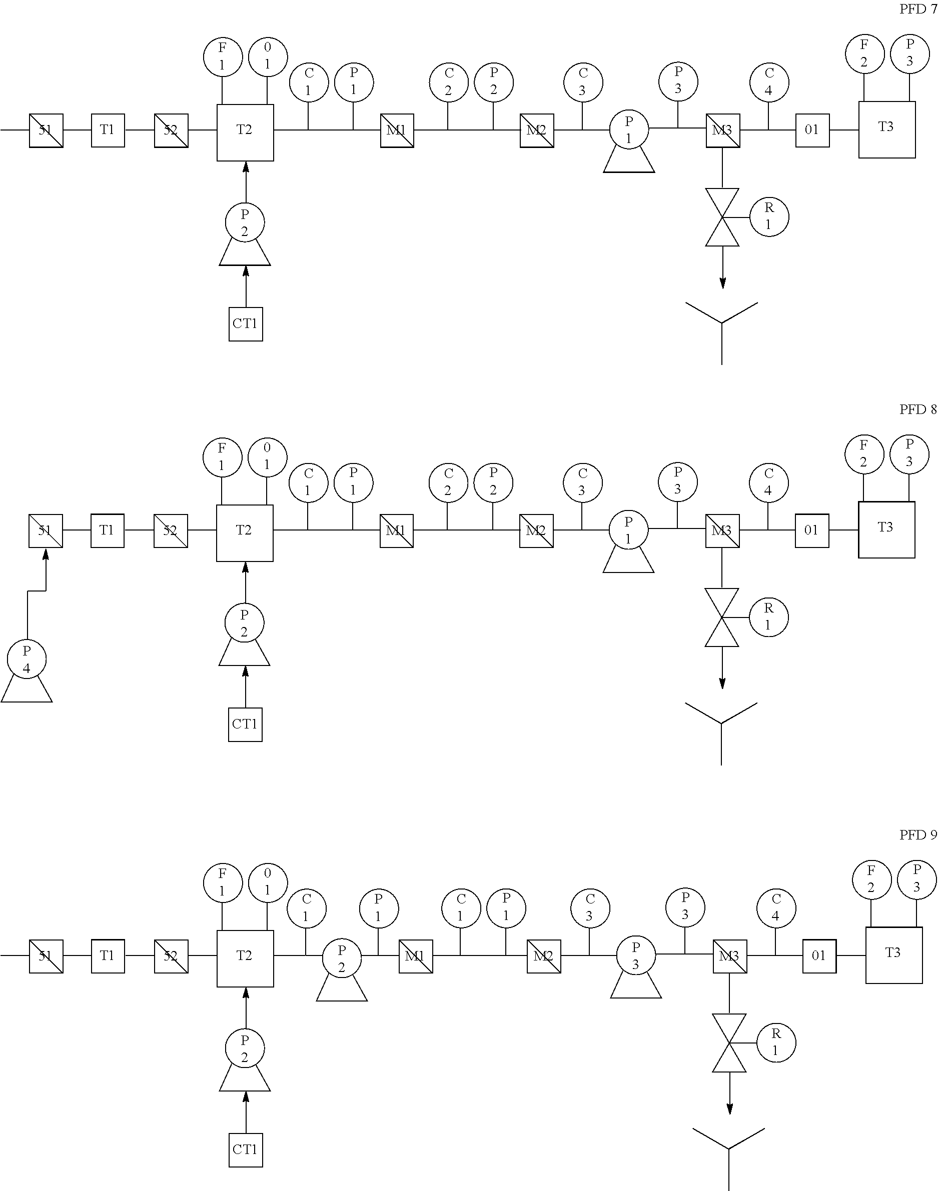

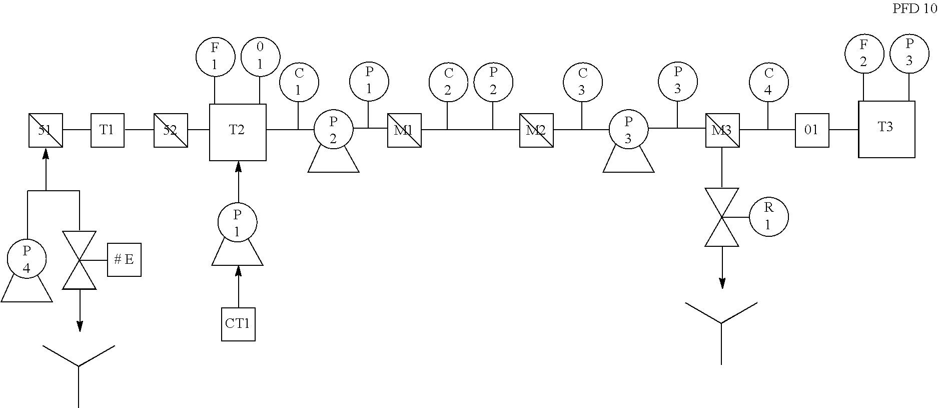

### Example

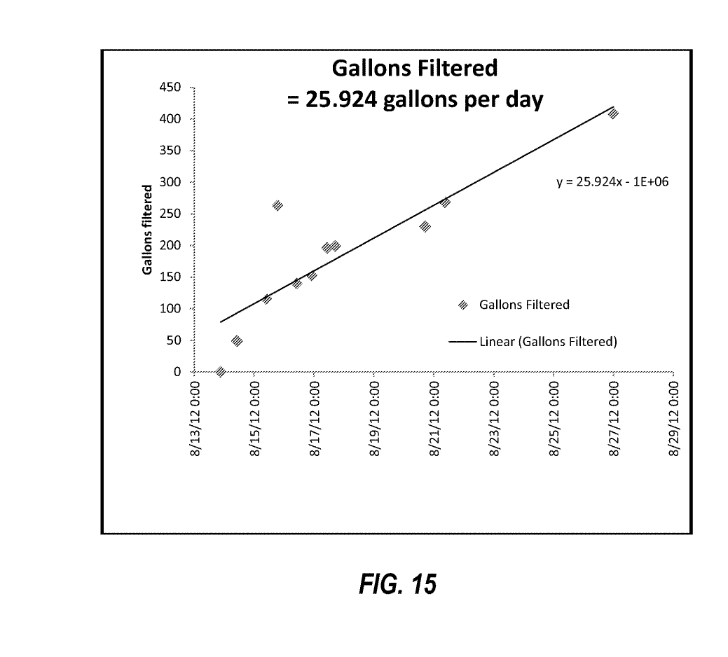

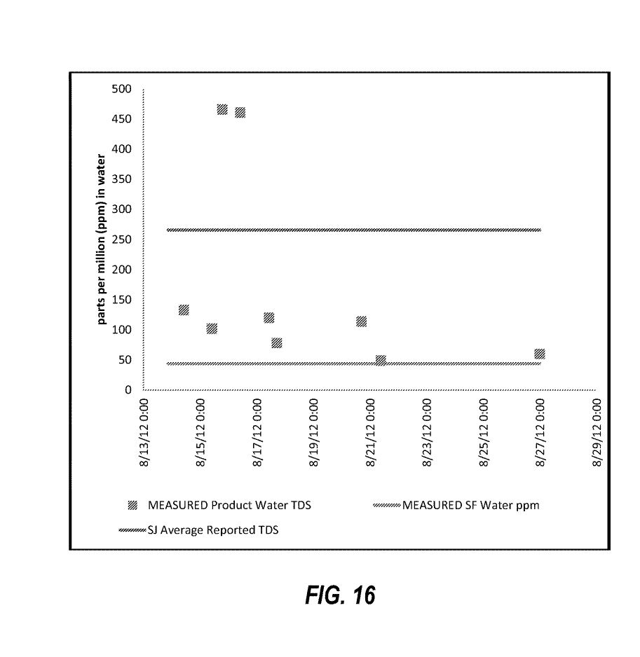

FIGS. 15-16 show filtration data from a system with a PFD similar to PFD 2. The system comprised two membranes, M1 and M2. It did not contain M3 or O1. M1 was an AM. M2 was not an AM. Water quality was measured daily using conductivity meters. The incoming wastewater was from a commercial 55 pound washing machine. The water quality after the M1 step was quantified using electrical conductivity and turbidity measurements. The difference in water quality before and after filtration is summarized in the Table 8.

TABLE 8

| M1 Filtrate Water | Turbidity | Rejec- | Conduc- | Rejec- |
|---|---|---|---|---|
| Quality | NTU | tion | tivity | tion |
| Wastewater | 354; 354; 354 | N/A | 424 ppm | N/A |
| zNano NUF | 28.5; 28.7; 28.8 | 91.9% | 361 ppm | 14.9% |
| Membrane | | | | |
| Filtered Water | | | | |

Of additional benefit was the pH of the filtrate was greater than the pH of tap water. Because soaps and surfactants are more effective at higher pH, reclaiming and reusing higher pH water for washing objects likes clothes and cars is desirable. Table 9 summarizes the increase in pH for the filtered water and compares it to tap water. Total chlorine is the concentration of inactive chloroamines. This type of chlorine does not damage the membrane. Free chlorine is the concentration of C1₂. The membrane M2 warranty requires less than 1 ppm of free chlorine.

TABLE 9

| Water pH and Chlorine Content | pH | TCl ppm | Cl ppm |
|---|---|---|---|
| Wastewater | 8.4 | 5 | 0 |
| PFD FIG. 2 Filtered Water | 8.4 | 1 | 0 |
| Tap Water | 7.2 | 5 | 0 |

The system performance and power consumption for complete system is listed in Table 10. The first column is the water pressure at each stage of filtration. The second column is the amount of water at each stage that was not filtered. The third column is the amount of water filtered at each stage. The filtration rate of M2 was greater than M1 because the pressure at M1 was much less than the pressure at M2. The result was discontinuous filtration by M2. The fourth column is the recovery percentage. Classically, recovery percentage is the ratio of treated water to input water. The fifth column is the estimated energy consumption of each stage. A booster pump was used for the first stage which consumed energy. The final column is how frequent each stage was cleaned.

TABLE 10

| | | Maximum Retentate | Maximum Permeate | | Energy Use | Auto Flushing |
|---|---|---|---|---|---|---|
| Pressure | | Gallons Per Minute | Gallons Per Minute | Recovery | Estimate | Frequency |
| 22 | PSI | O | 0.7 | 100% | 0.115 kW | Daily |
| 150 | PSI | >1.2 | 0.63 | 34% | 0.575 kW | Daily |

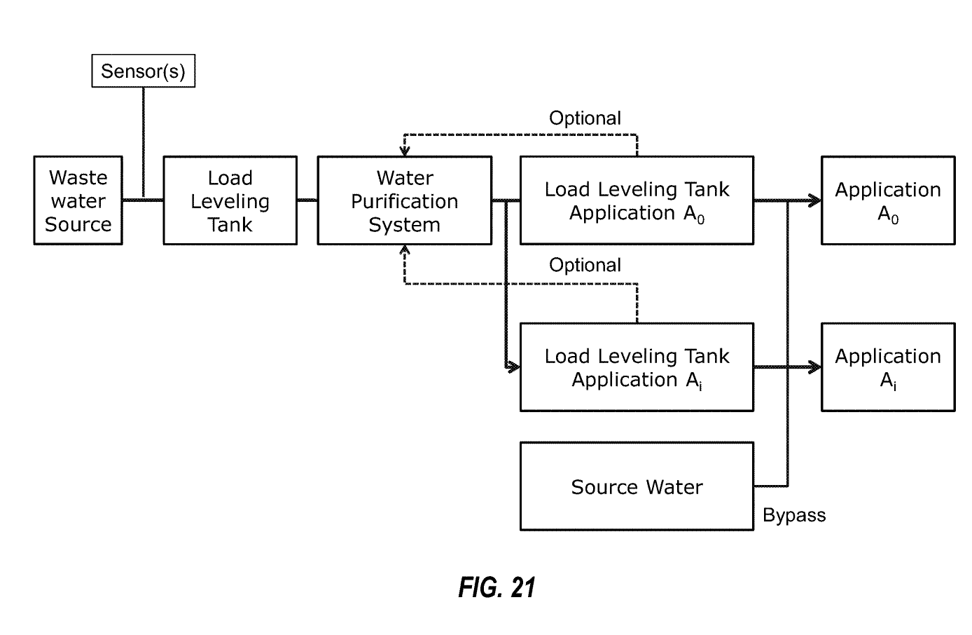

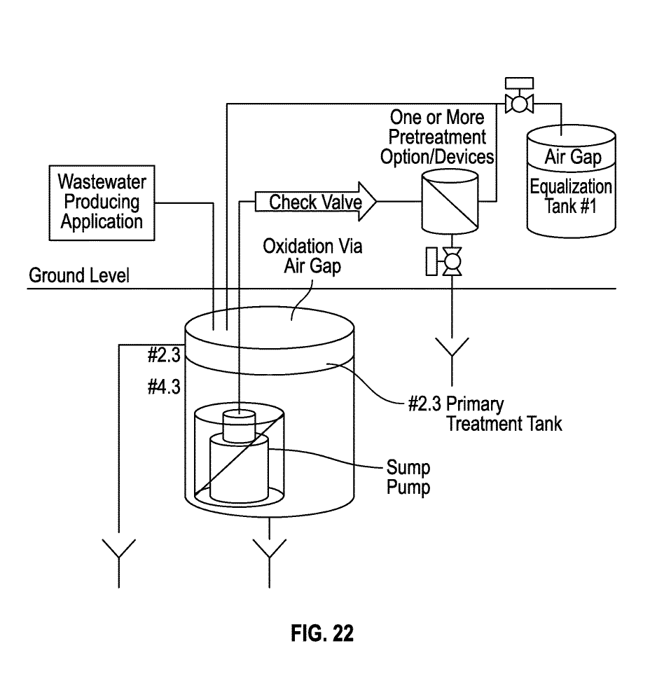

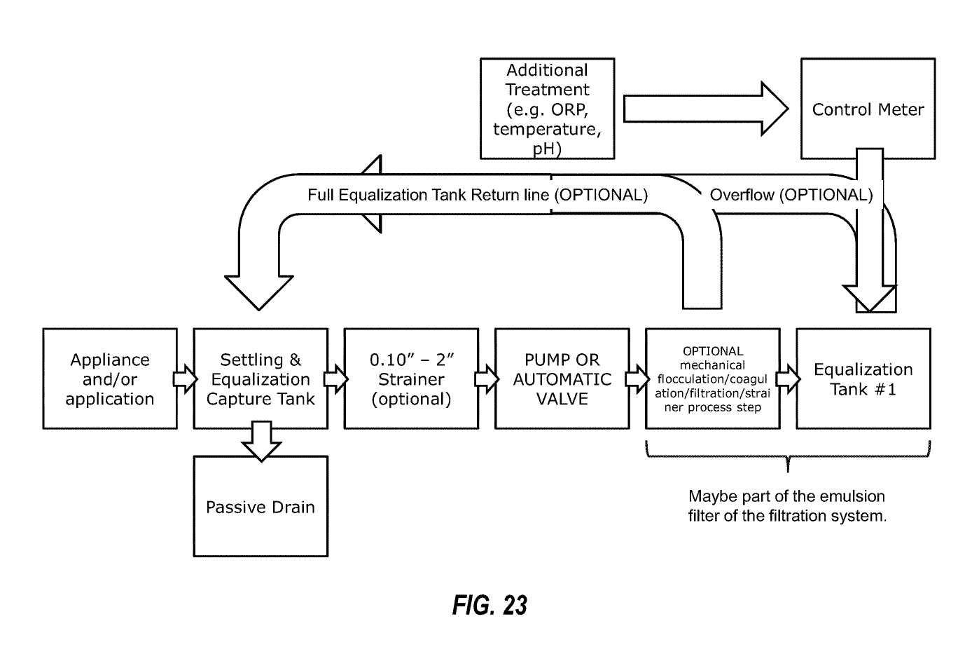

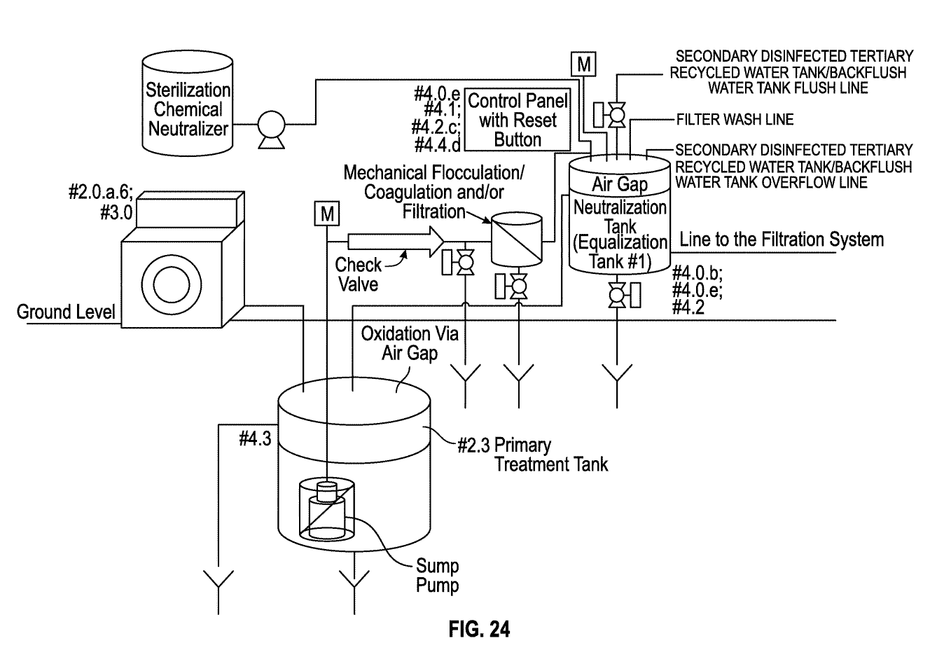

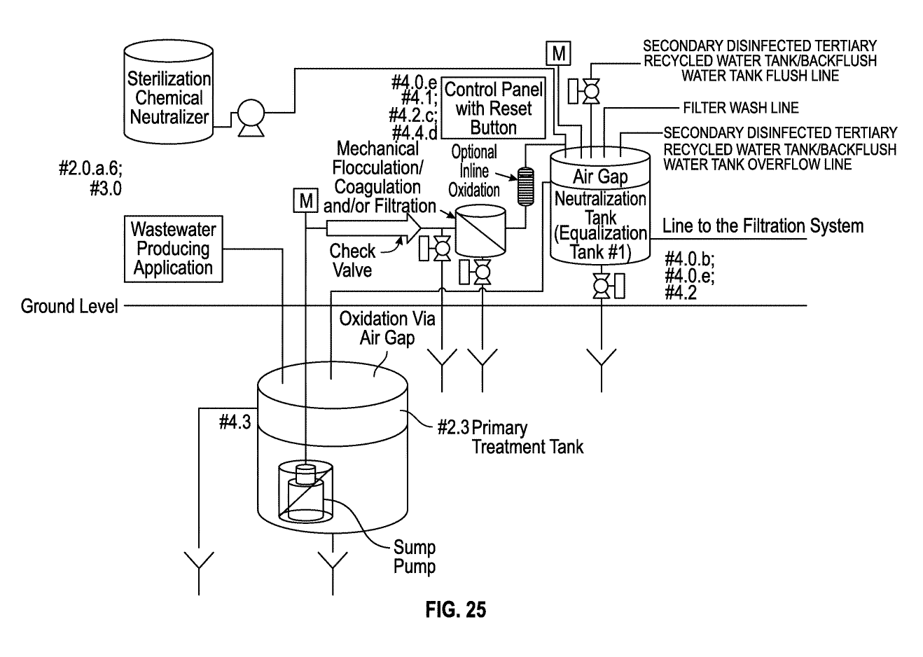

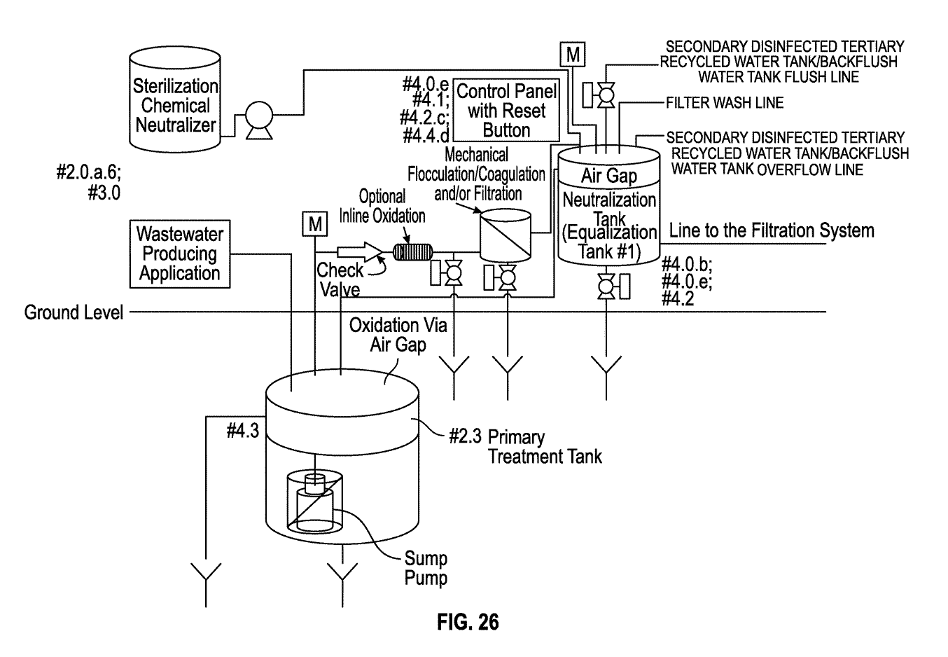

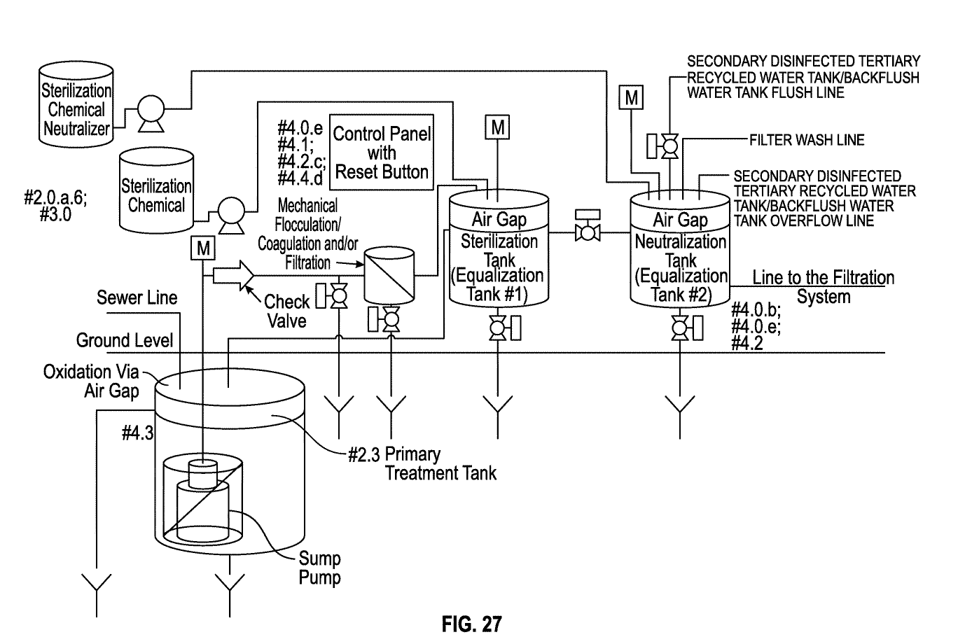

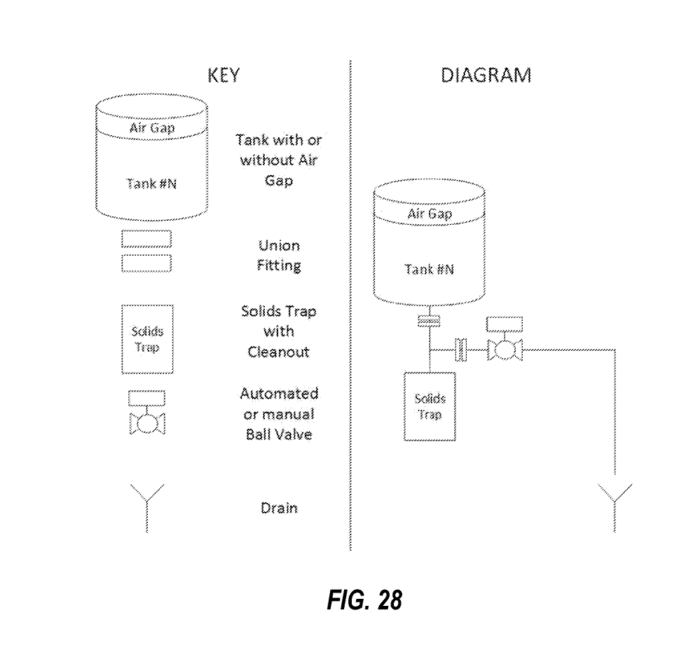

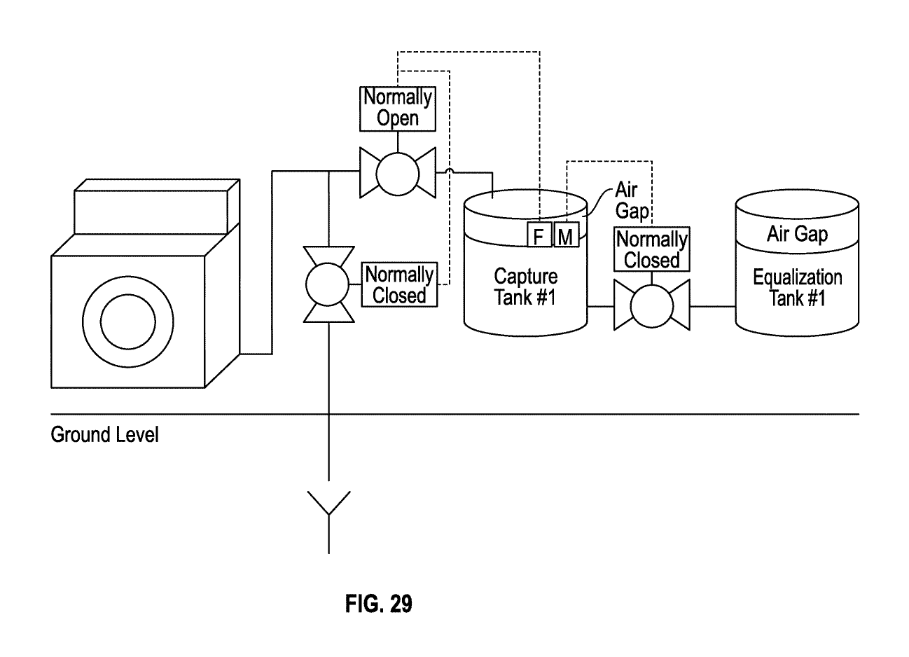

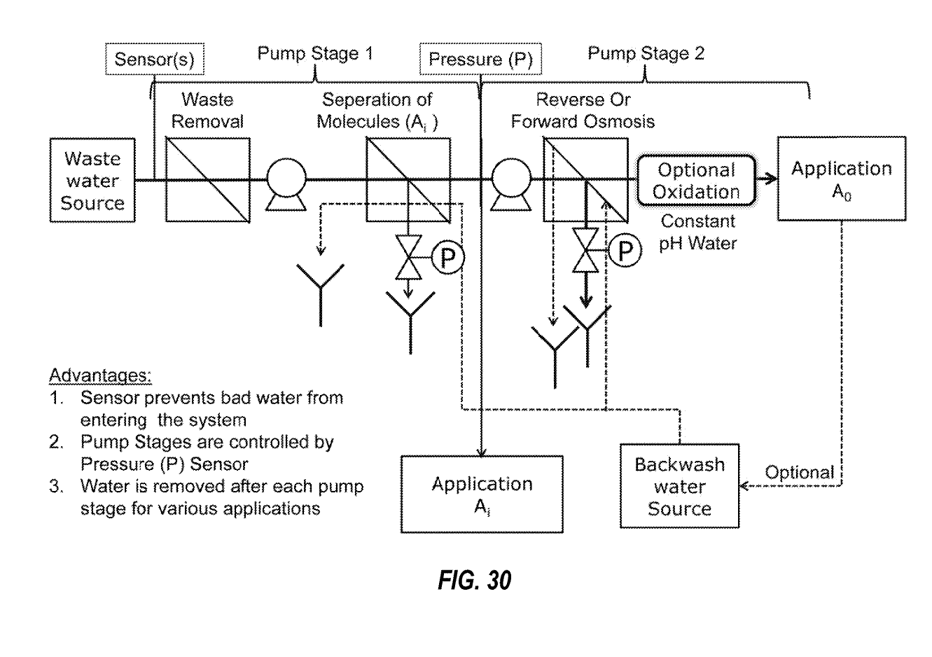

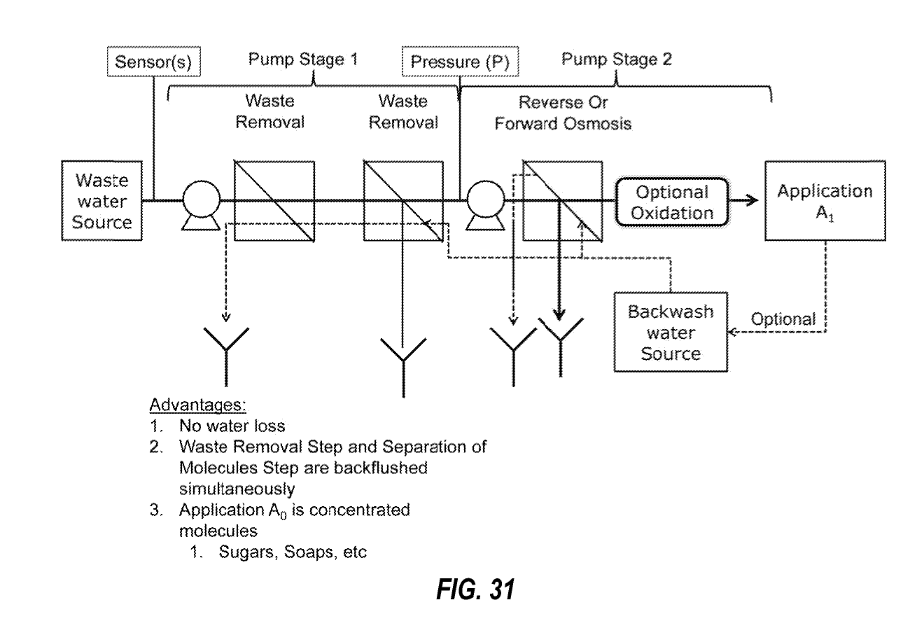

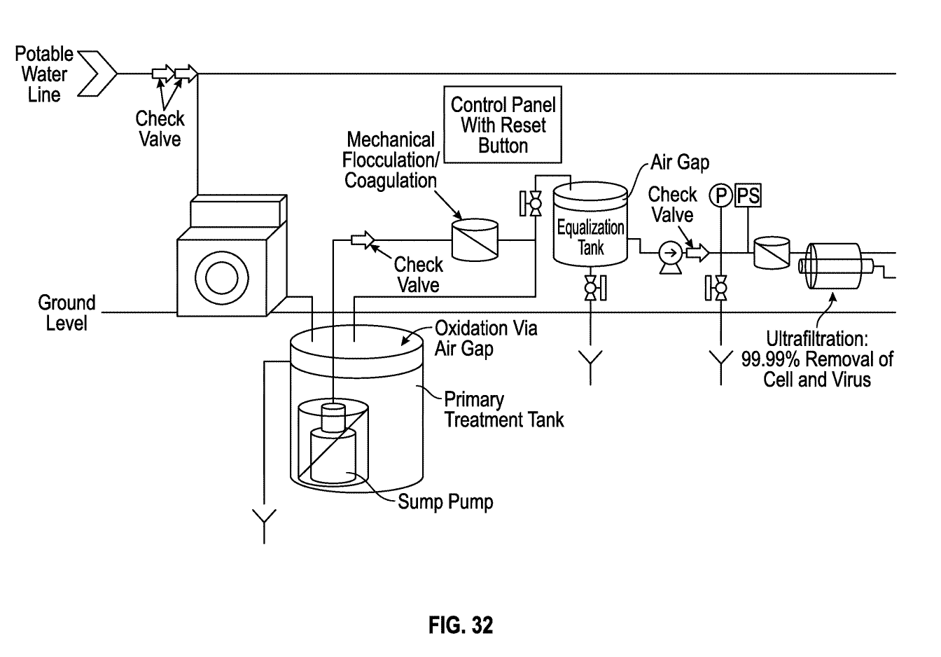

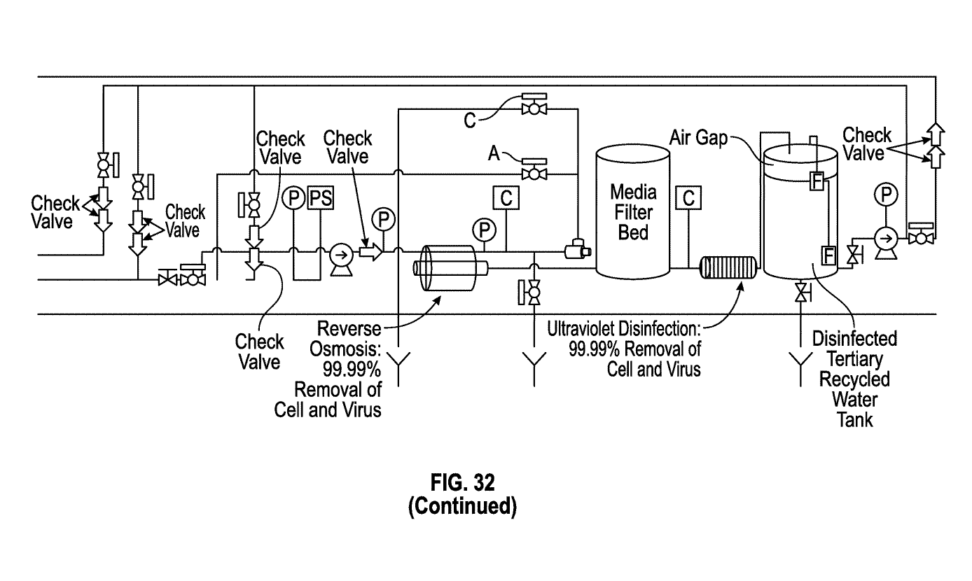

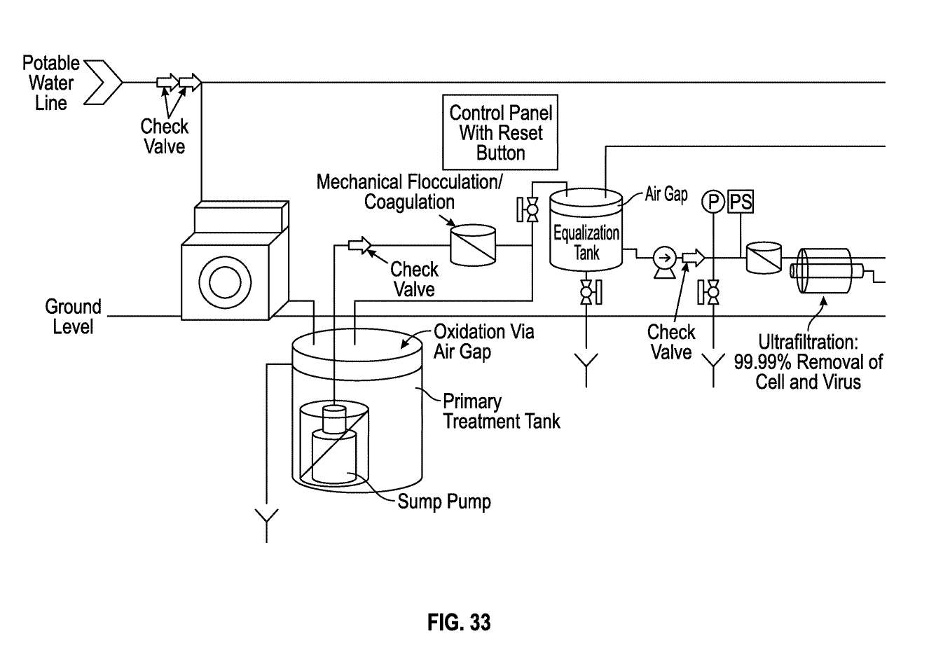

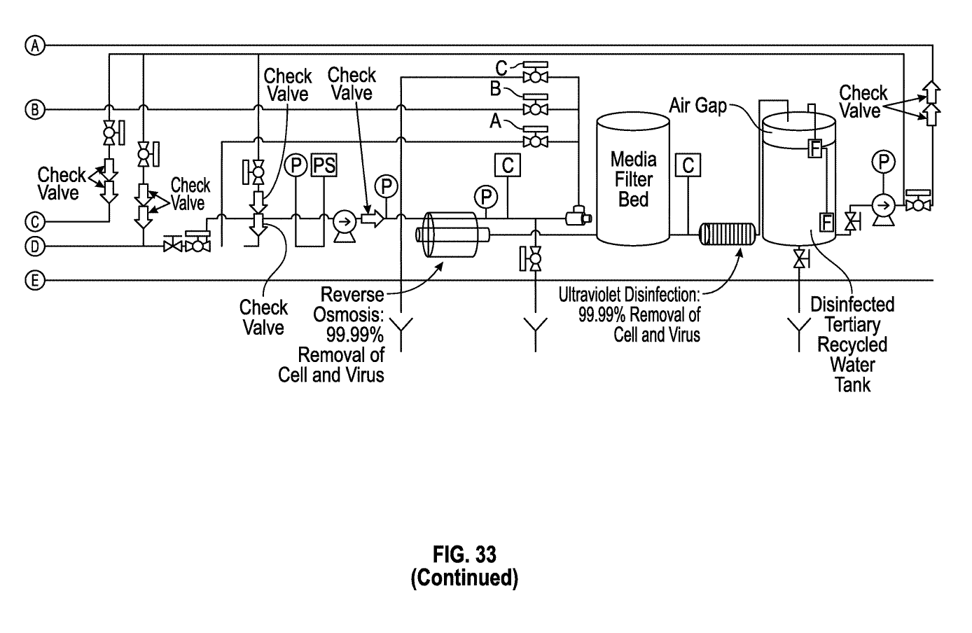

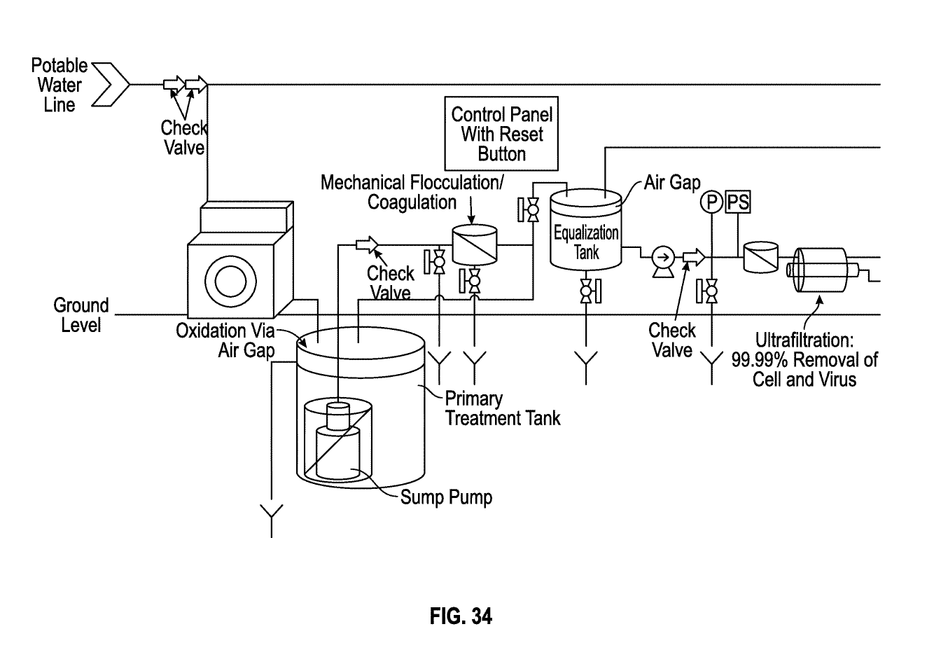

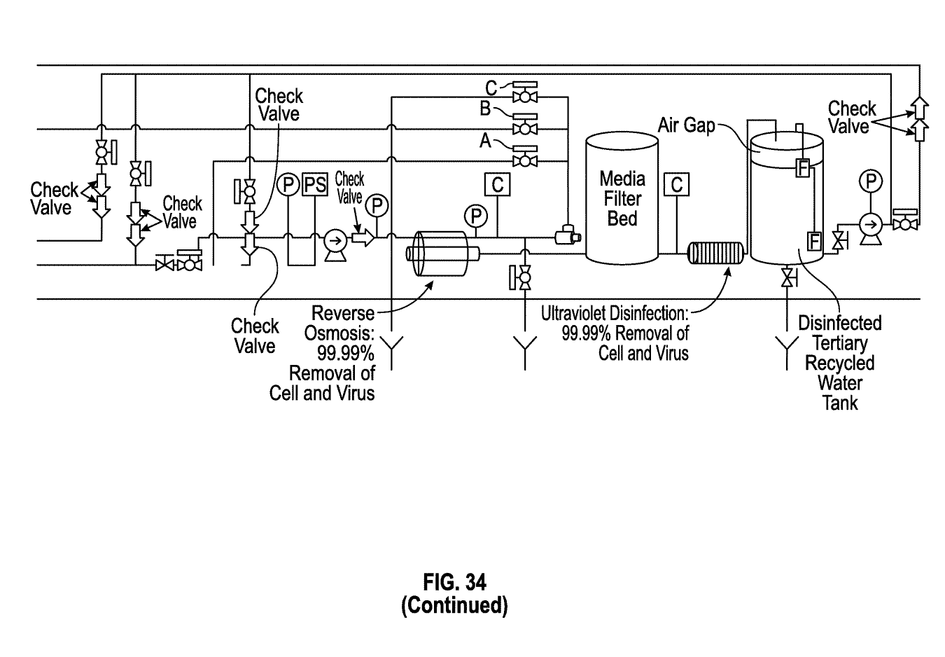

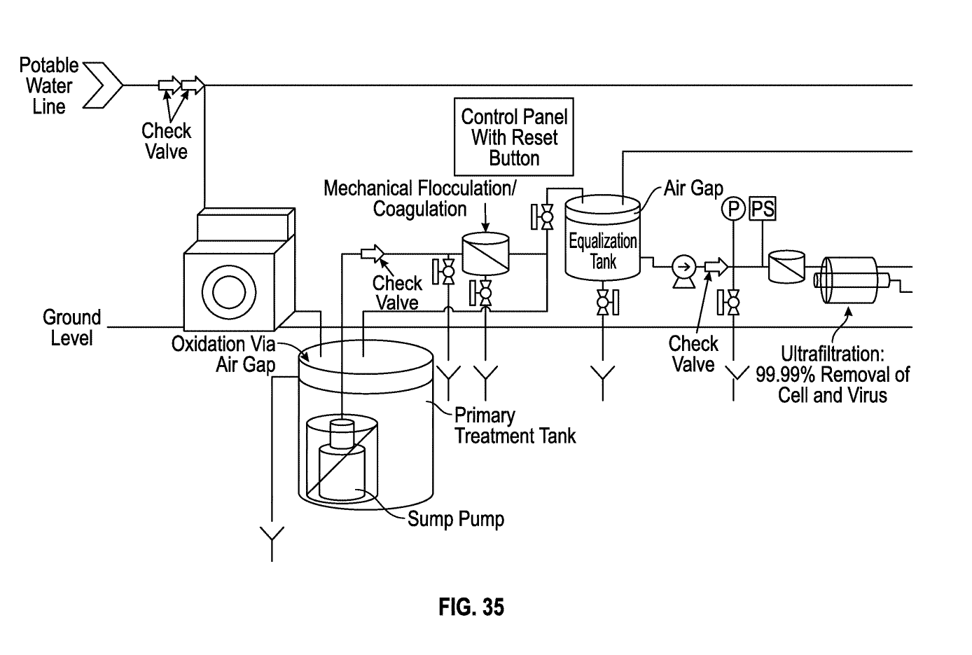

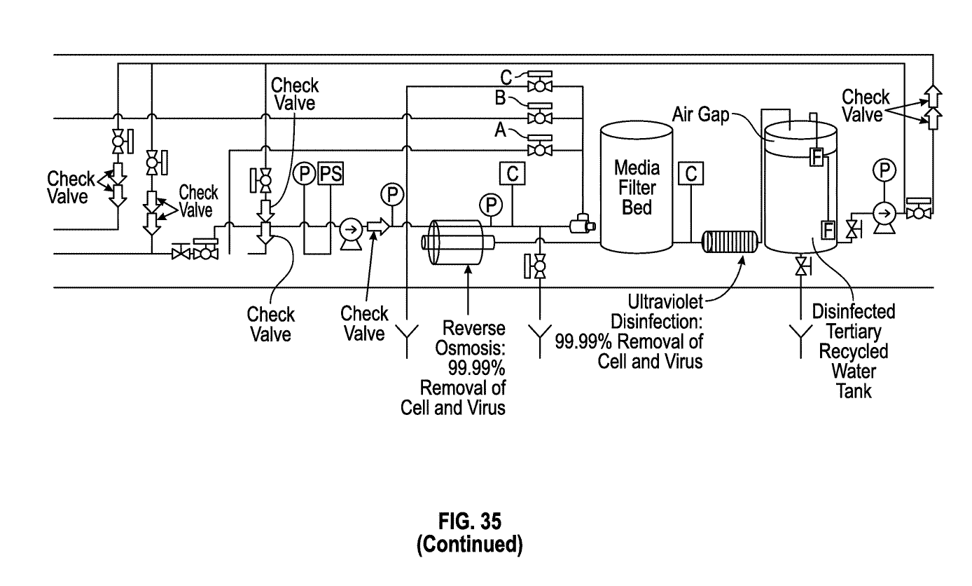

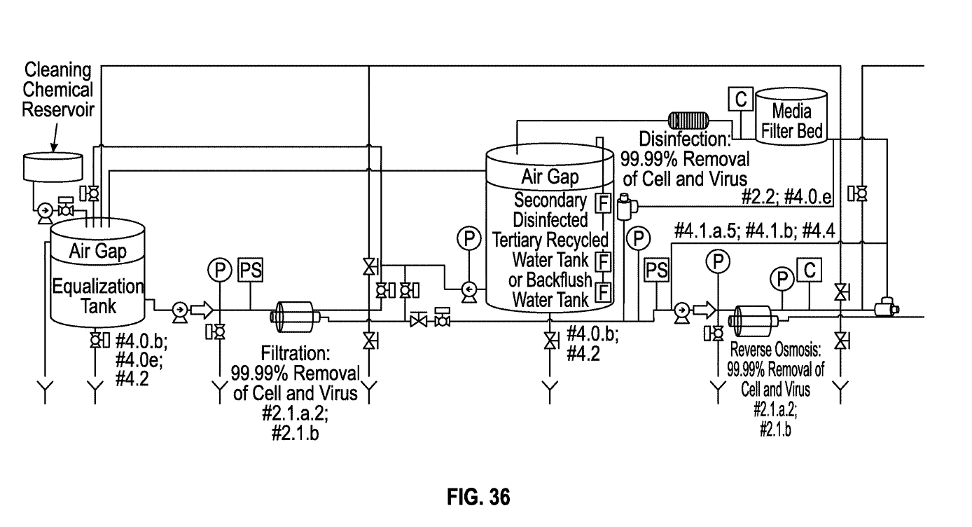

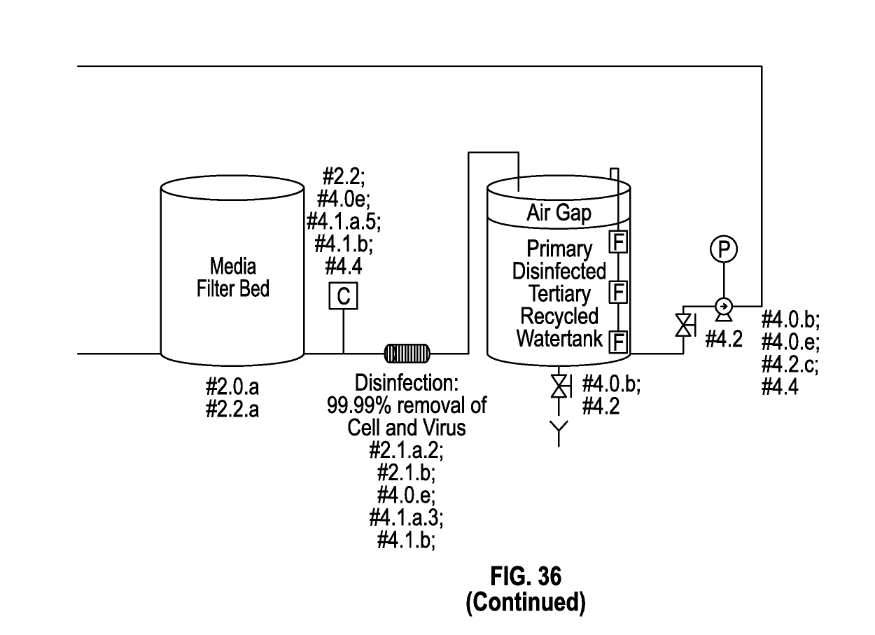

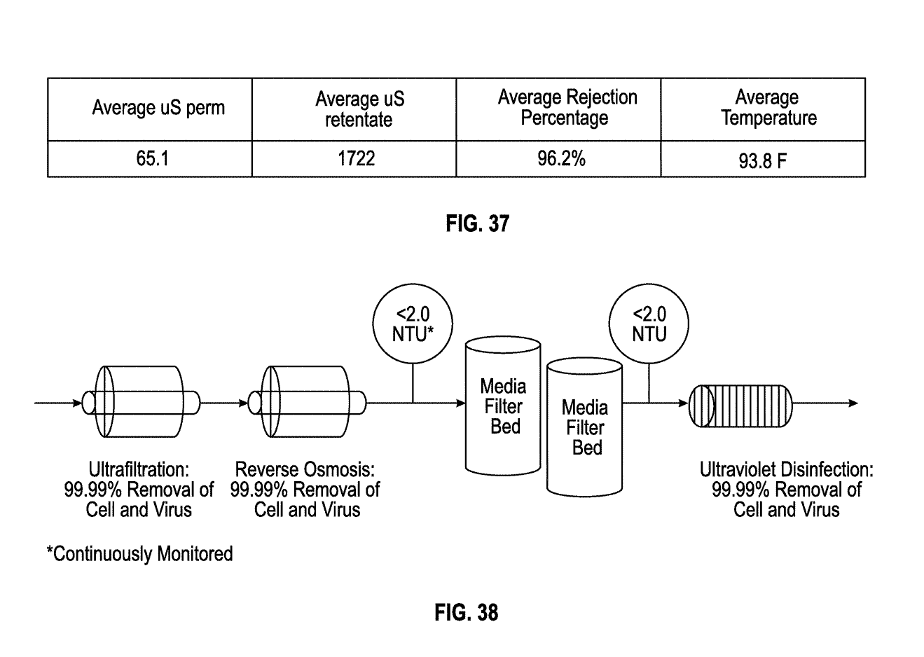

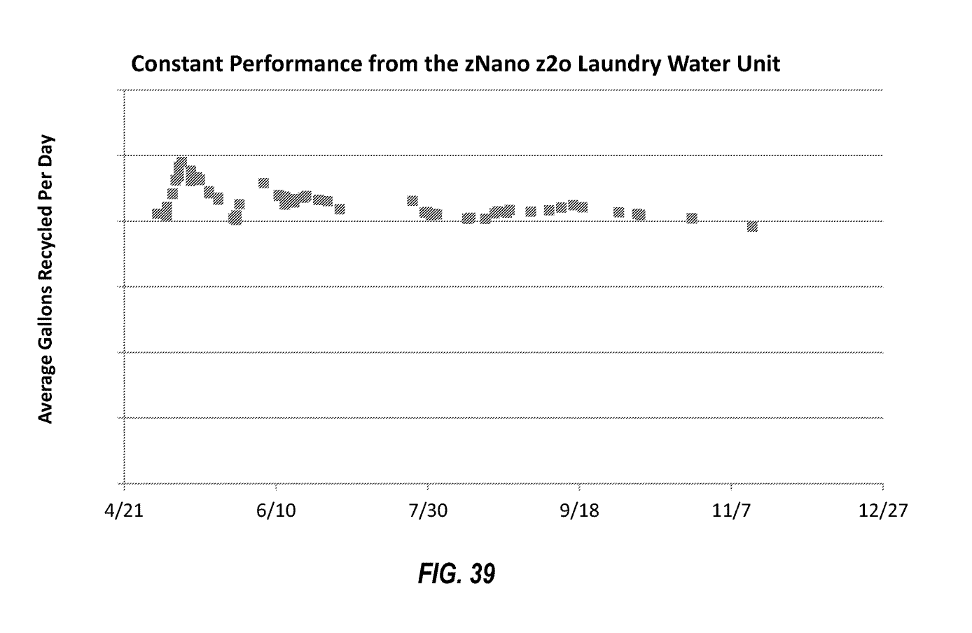

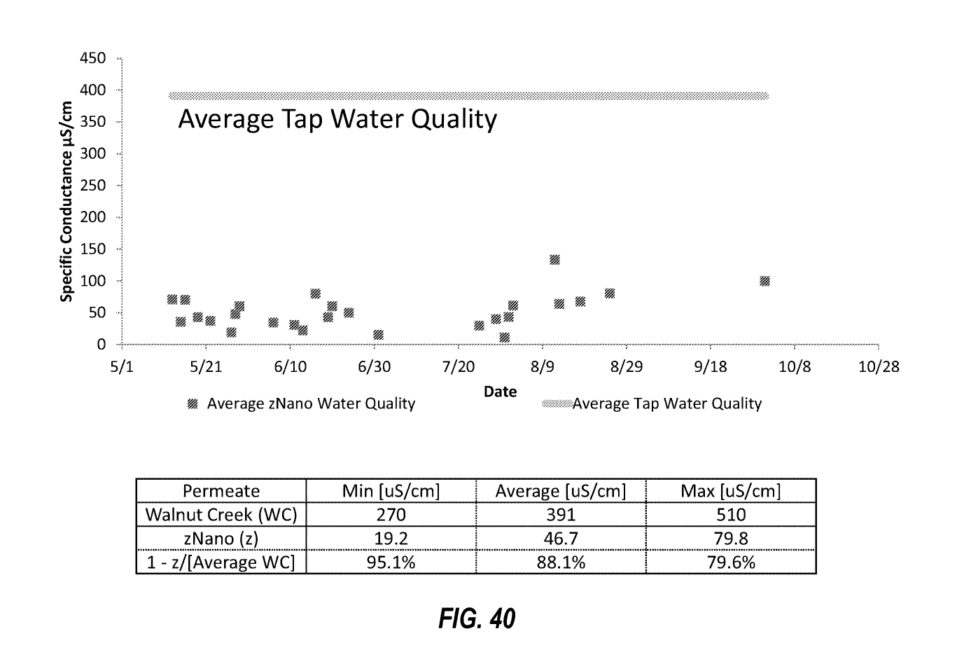

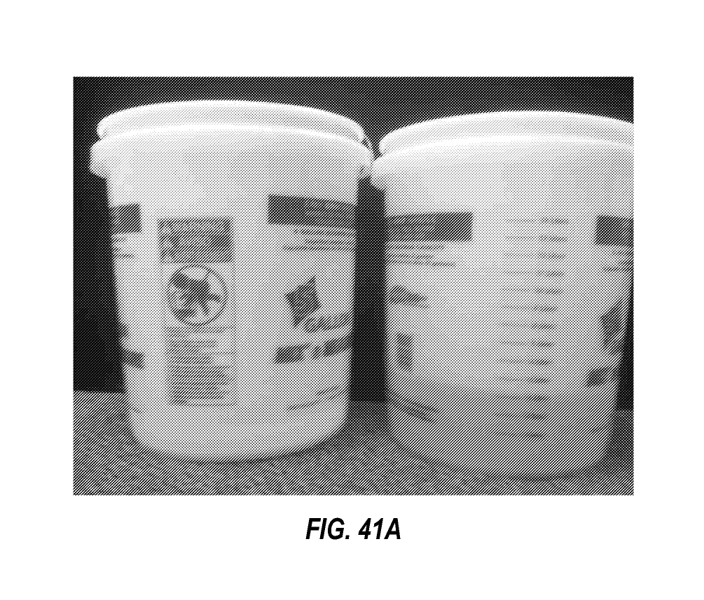

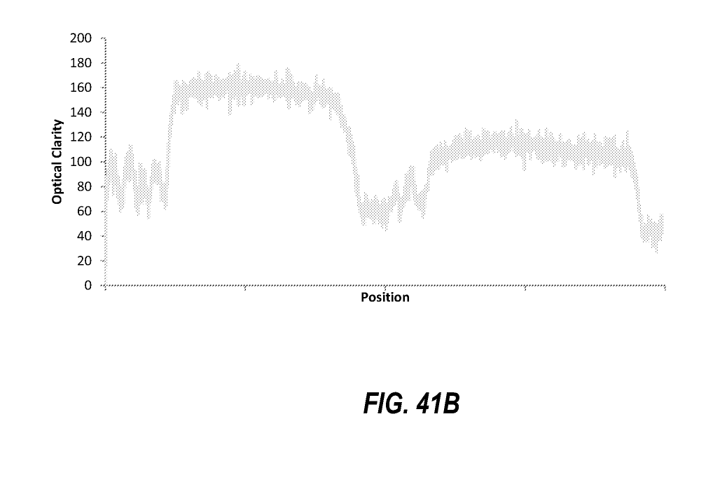

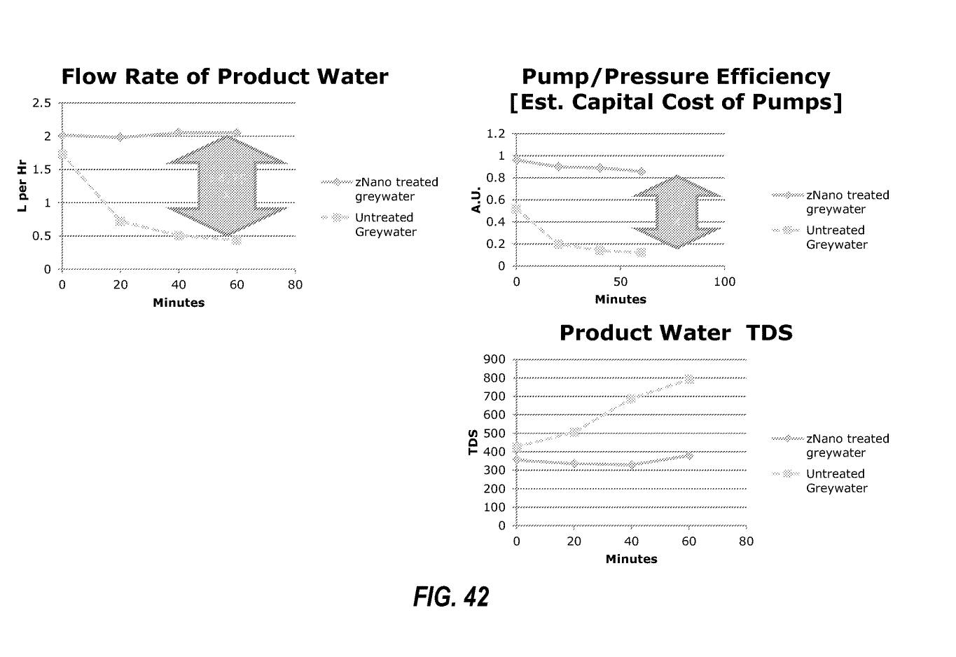

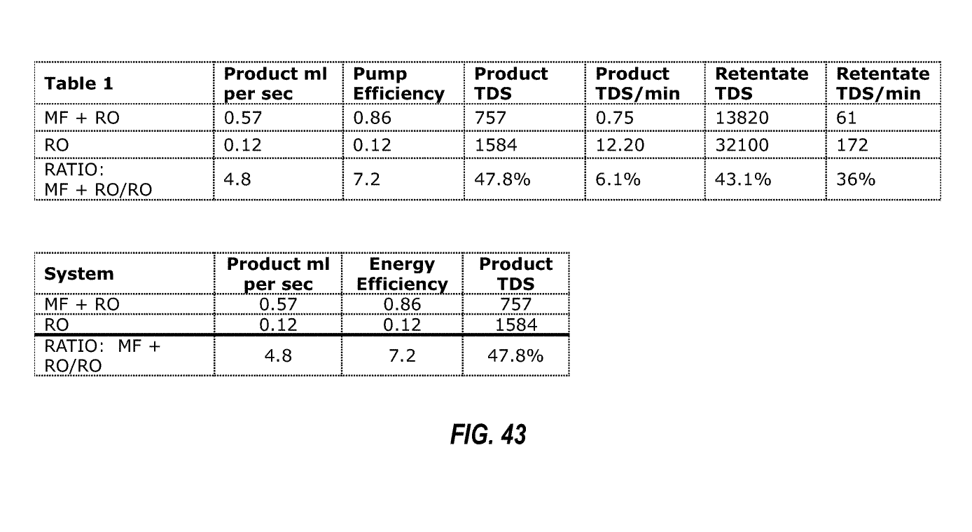

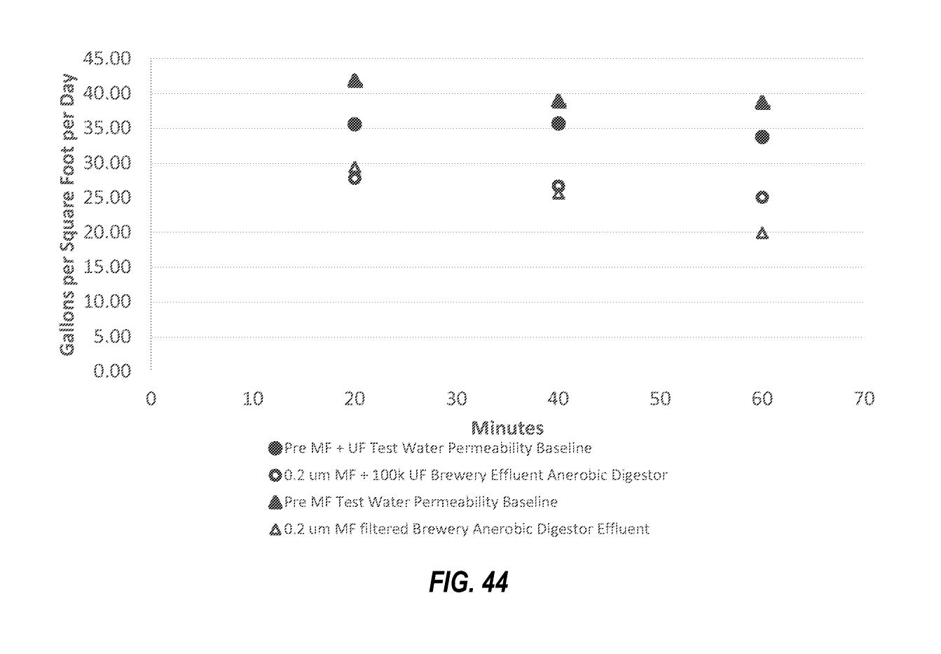

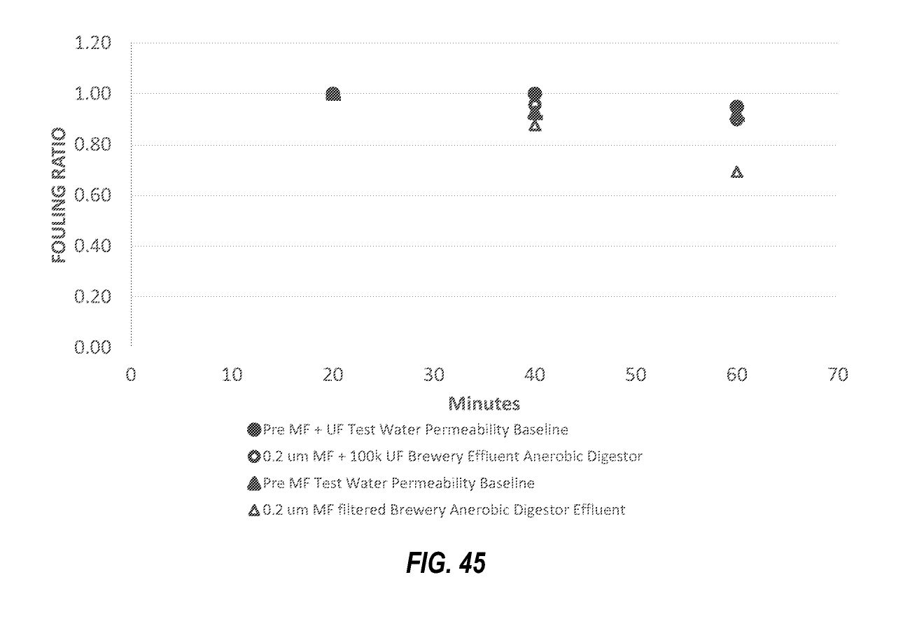

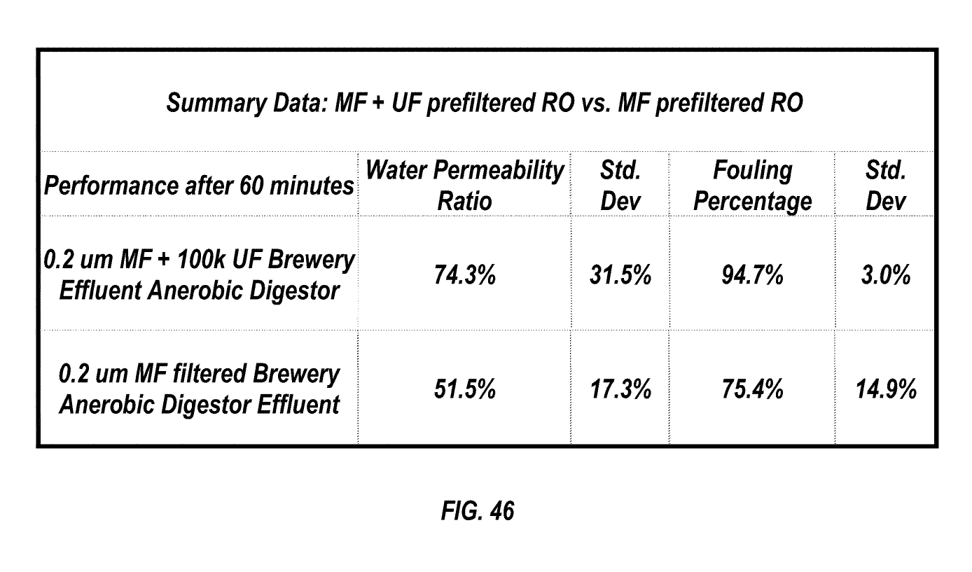

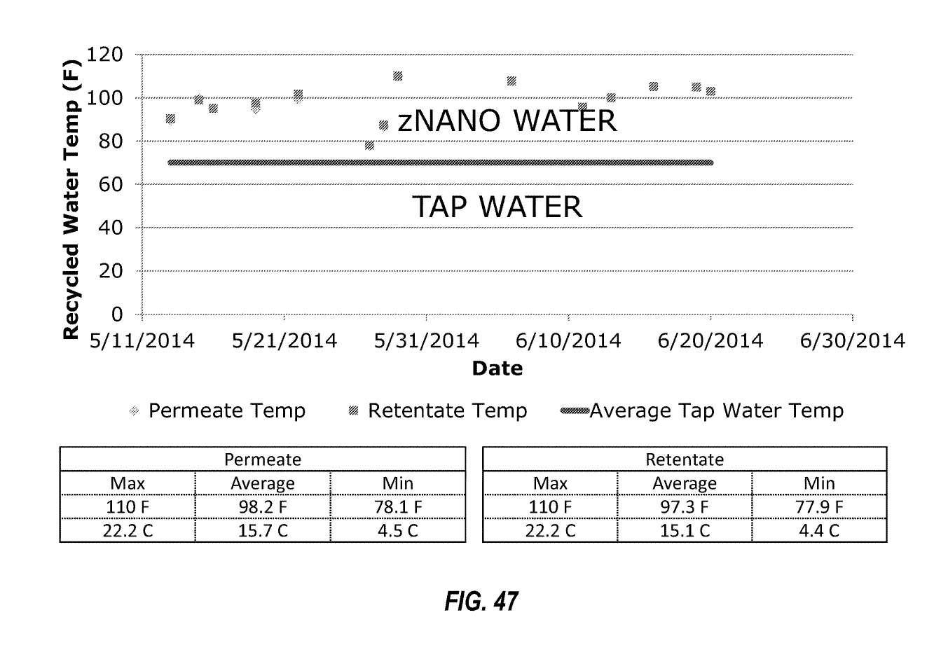

As shown in FIGS. 1, 8, 9, 21, and 30, wastewater from specific parts of the treatment process may be clean enough to be used for other applications. Applications include the wash cycle for cars, wetting clothes, irrigation, washing down buildings, toilet flushing, and other approved recycled water applications. The waste from the reverse osmosis can be made into disinfected tertiary treated recycled water by processing the wastewater through a sterilization filter and a disinfection step.

Although the invention has been described in detail with particular reference to the described embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. A system for treating wastewater, the system comprising one or more filtration membranes upstream of a reverse osmosis element.

2. The system of claim 1 wherein one of the filtration membranes is a microfiltration membrane.

3. The system of claim 1 wherein one of the filtration membranes is an ultrafiltration membrane.

4. The system of claim 1 further comprising a media filter downstream of the reverse osmosis element.

5. The system of claim 4 where in the media filter is used solely to reduce turbidity.
